(19) United States
(12) Patent Application Publication
(10) Pub. No.: US 2016/0238751 A1
(43) Pub. Date: Aug. 18, 2016

(54) LIGHT-DIFFUSING MEMBER, METHOD FOR MANUFACTURING THE SAME, AND DISPLAY DEVICE

(71) Applicant: Sharp Kabushiki Kaisha, Osaka-shi, Osaka (JP)

(72) Inventors: Toru KANNO, Osaka-shi (JP); Hideomi YUI, Osaka-shi (JP); Tsuyoshi KAMADA, Osaka-shi (JP); Tsuyoshi MAEDA, Osaka-shi (JP)

(21) Appl. No.: 14/900,250

(22) PCT Filed: Jul. 4, 2014
(86) PCT No.: PCT/JP2014/067867

§ 371 Date: Dec. 21, 2015

(30) Foreign Application Priority Data
Jul. 5, 2013 (JP) 2013-142009

(51) Int. Cl. G02B 5/02

(52) U.S. Cl. CPC G02B 5/0268

(57) ABSTRACT

A method for manufacturing a light-diffusing member includes a process of forming a light shielding layer on one surface of a substrate (30); a process of forming a negative photosensitive resin layer on the one surface of the substrate (30) so as to cover the light shielding layer; a process of exposing the negative photosensitive resin layer by irradiating the negative photosensitive resin layer with parallel light of ultraviolet light diagonally with respect to a normal direction of the one surface of the substrate (30) from a surface opposite to the one surface of the substrate (30) on which the light shielding layer and the negative photosensitive resin layer are formed in at least one direction through a region of the substrate (30) other than a region where the light shielding layer is formed; and a process of forming a light-diffusing section, which includes a light emission end surface on a side close to the substrate (30) and a light incident end surface having an area greater than an area of the light emission end surface on a side opposite to the substrate (30), on the one surface of the substrate (30) by developing the exposed negative photosensitive resin layer.

### TECHNICAL FIELD

The present invention relates to a light-diffusing member, a method for manufacturing the same, and a display device.

The present application claims priority to Japanese Patent Application No. 2013-142009 filed in the Japanese Patent Office on Jul. 5, 2013, the disclosure of which is herein incorporated by reference in its entirety.

### BACKGROUND ART

A liquid crystal display device has been widely used as a display of a mobile electronic device including a mobile phone, a television, or a personal computer. Incidentally, it has been generally known in the past that the liquid crystal display device has excellent visual perception properties from a front surface but has a narrow viewing angle, and various studies for widening the viewing angle have been performed. As one study, it is considered that a member (hereinafter, referred to as a light-diffusing member) for diffusing light emitted from a display member of a liquid crystal panel is provided on a visual perception side of the display member.

For example, PTL 1 describes a viewing angle widening film that includes a sheet main member and a plurality of substantially wedge-shaped portions which is buried on an emission surface within the sheet main member and becomes wider toward the emission surface. In the viewing angle widening film, the side surface of the substantially wedge-shaped portion is provided with polygonal surfaces, and an angle formed by a vertical line of an incident surface and the polygonal surface of the side surface becomes larger toward the emission surface. In the viewing angle widening film, since the side surface of the substantially wedge-shaped portion has such a configuration, light vertically incident on the incident surface is totally reflected on the side surfaces multiple times, and thus, a diffusing angle becomes larger.

### CITATION LIST

### Patent Literature

PTL 1: Japanese Unexamined Patent Application Publication No. 2005-157216

### SUMMARY OF INVENTION

### Technical Problem

In a case where the viewing angle widening film described in PTL 1 is manufactured, it is extremely difficult to form the substantially wedge-shaped portions having the side surfaces provided with the plurality of polygonal surfaces on the sheet main member. There is an inconvenience of filling the substantially wedge-shaped portions with UV curable resin without gaps after the substantially wedge-shaped portions are formed on the sheet main member, and a manufacturing process is complicated. If a problem such as a case where the inclined angle of the polygonal surface is not accurately formed or a case where the substantially wedge-shaped portions are not sufficiently filled with the resin occurs, there is a problem that desired light-diffusing performance is not obtained.

An aspect of the present invention has been made in view of the above-described circumstances, and it is an object of the present invention to provide a method for manufacturing a light-diffusing member capable of achieving a desired light-diffusing function without complicating a manufacturing process. It is also an object of the present invention to provide a light-diffusing member manufactured by the method for manufacturing a light-diffusing member. It is also an object of the present invention to provide a display device including the light-diffusing member with excellent display quality.

### Solution to Problem

According to an aspect of the present invention, there is provided a method for manufacturing a light-diffusing member. The manufacturing method includes: a process of forming a light shielding layer on one surface of a substrate having light transparency; a process of forming a negative photosensitive resin layer having light transparency on the one surface of the substrate so as to cover the light shielding layer; a process of exposing the negative photosensitive resin layer by irradiating the negative photosensitive resin layer with parallel light of ultraviolet light diagonally with respect to a normal direction of the one surface of the substrate from a surface opposite to the one surface of the substrate on which the light shielding layer and the negative photosensitive resin layer are formed in at least one direction through a region of the substrate other than a region where the light shielding layer is formed; and a process of forming a light-diffusing section, which includes a light emission end surface on a side close to the substrate and a light incident end surface having an area greater than an area of the light emission end surface on a side opposite to the substrate, on the one surface of the substrate by developing the exposed negative photosensitive resin layer.

In the method for manufacturing a light-diffusing member according to the aspect of the present invention, it is preferable that the negative photosensitive resin layer is irradiated with the parallel light diagonally with respect to the normal direction of the one surface of the substrate in two or more different directions.

In the method for manufacturing a light-diffusing member according to the aspect of the present invention, it is preferable that angles of the parallel light applied in two or more different directions with respect to the normal direction of the one surface of the substrate are different from each other.

In the method for manufacturing a light-diffusing member according to the aspect of the present invention, it is preferable that the negative photosensitive resin layer is irradiated with the parallel light diagonally with respect to the normal direction of the one surface of the substrate in at least one direction and the negative photosensitive resin layer is irradiated with the parallel light in parallel with the normal direction of the one surface of the substrate.

In the method for manufacturing a light-diffusing member according to the aspect of the present invention, it is preferable that an angle of the applied parallel light with respect to the normal direction of the one surface of the substrate is controlled by the arrangement of the substrate and a light source which emits the parallel light.

In the method for manufacturing a light-diffusing member according to the aspect of the present invention, it is preferable that the light source includes a plurality of surface light sources and the plurality of surface light sources is arranged in different directions from one another with respect to the normal direction of the one surface of the substrate.

In the method for manufacturing a light-diffusing member according to the aspect of the present invention, it is preferable that the light source includes a line light source and the line light source is moved in the normal direction of the one surface of the substrate.

In the method for manufacturing a light-diffusing member according to the aspect of the present invention, it is preferable that a prism is disposed so as to face the substrate, and the angle of the applied parallel light with respect to the normal direction of the one surface of the substrate is controlled by refracting the parallel light emitted from a light source by the prism.

A light-diffusing member according to another aspect of the present invention may be manufactured by the method for manufacturing a light-diffusing member according to the aspect of the present invention.

A display device according to still another aspect of the present invention may include the light-diffusing member according to the aspect of the present invention.

### Advantageous Effects of Invention

According to the aspect of the present invention, it is possible to provide a method for manufacturing a light-diffusing member capable of achieving a desired light-diffusing function without complicating a manufacturing process.

### BRIEF DESCRIPTION OF DRAWINGS

FIG. 1 is a schematic configuration diagram showing an example of an apparatus for manufacturing a light-diffusing member used in a method for manufacturing a light-diffusing member of the present embodiment.

FIG. 2 is a schematic configuration diagram showing a first embodiment of an exposure device.

FIG. 3 is a graph showing distribution characteristics of parallel light.

FIG. 4 is a diagram showing the relationship between an inclined angle of a substrate and an inclined angle (incident angle) of parallel light with respect to a normal line of the substrate.

FIG. 5 is a diagram showing the refraction of parallel light incident on the substrate.

FIG. 6 is a graph showing the relationship between an inclined angle of the substrate and a taper angle of a light-diffusing section.

FIG. 7 is a diagram showing the refraction of parallel light incident on the substrate.

FIG. 8 is a schematic sectional view showing an embodiment of the light-diffusing member.

FIG. 9 is a schematic configuration diagram showing a second embodiment of the exposure device.

FIG. 10 is a schematic configuration diagram showing a third embodiment of the exposure device.

FIG. 11 is a schematic configuration diagram showing a fourth embodiment of the exposure device.

FIG. 12 is a schematic configuration diagram showing a fifth embodiment of the exposure device.

FIG. 13 is a schematic configuration diagram showing a sixth embodiment of the exposure device.

FIG. 14 is a schematic configuration diagram showing a seventh embodiment of the exposure device.

FIG. 15 is a schematic configuration diagram showing an eighth embodiment of the exposure device.

FIG. 16 is a diagram showing a state in which the substrate is irradiated with the parallel light in the method for manufacturing a light-diffusing member of the present embodiment.

FIG. 17 is a diagram showing a state in which the substrate is irradiated with the parallel light in the method for manufacturing a light-diffusing member of the present embodiment.

FIG. 18 is a diagram showing a state in which the substrate is irradiated with the parallel light in the method for manufacturing a light-diffusing member of the present embodiment.

FIG. 19 is a schematic configuration diagram showing a ninth embodiment of the exposure device.

FIG. 20 is a schematic configuration diagram showing a tenth embodiment of the exposure device.

FIG. 21 is a schematic configuration diagram showing an eleventh embodiment of the exposure device.

FIG. 22 is a schematic sectional view showing an embodiment of the light-diffusing member.

FIG. 23 is a schematic configuration diagram showing a twelfth embodiment of the exposure device.

FIG. 24 is a schematic sectional view showing an embodiment of the light-diffusing member.

FIG. 25 is a schematic configuration diagram showing a thirteenth embodiment of the exposure device.

FIG. 26 is a schematic sectional view showing an embodiment of the light-diffusing member.

FIG. 27 is a schematic configuration diagram showing a fourteenth embodiment of the exposure device.

FIG. 28 is a diagram showing a state in which the parallel light is incident on the substrate through a prism.

FIG. 29 is a diagram showing the refraction of parallel light incident on the prism.

FIG. 30 is a graph showing the relationship between an inclined angle of the prism and an inclined angle of light emitted from the bottom surface of the prism.

FIG. 31 is a graph showing the relationship between the inclined angle of light emitted from the bottom surface of the prism and a taper angle of the light-diffusing section.

FIG. 32 is a schematic configuration diagram showing a case where a plurality of prisms is used in the fourteenth embodiment of the exposure device.

FIG. 33 is a schematic configuration diagram showing a fifteenth embodiment of the exposure device.

FIG. 34 is a schematic configuration diagram showing the fifteenth embodiment of the exposure device.

FIG. 35 is a schematic configuration diagram showing the fifteenth embodiment of the exposure device.

FIG. 36 is a schematic configuration diagram showing a sixteenth embodiment of the exposure device.

FIG. 37 is a schematic configuration diagram showing a seventeenth embodiment of the exposure device.

FIG. 38 is a schematic configuration diagram showing an eighteenth embodiment of the exposure device.

FIG. 39 is a schematic configuration diagram showing a nineteenth embodiment of the exposure device.

FIG. 40 is a schematic configuration diagram showing a twentieth embodiment of the exposure device.

FIG. 41 is a schematic configuration diagram showing the twentieth embodiment of the exposure device.

FIG. 42 is a schematic configuration diagram showing the twentieth embodiment of the exposure device.

FIG. 43 is a schematic configuration diagram showing a twenty-first embodiment of the exposure device.

FIG. 44 is a schematic configuration diagram showing the twenty-first embodiment of the exposure device.

FIG. 45 is a longitudinal sectional view showing an embodiment of a liquid crystal display device.

FIG. 46 is a longitudinal sectional view of a liquid crystal panel.

### DESCRIPTION OF EMBODIMENTS

Embodiments of a light-diffusing member, a method for manufacturing the same, and a display device of the present embodiment will be described.

The present embodiment is specifically described to allow those skilled in the art to more easily understand the gist of the invention, and is not limited to the present invention unless specified otherwise.

### Light-Diffusing Member and Method for Manufacturing the Same

### (1) First Embodiment

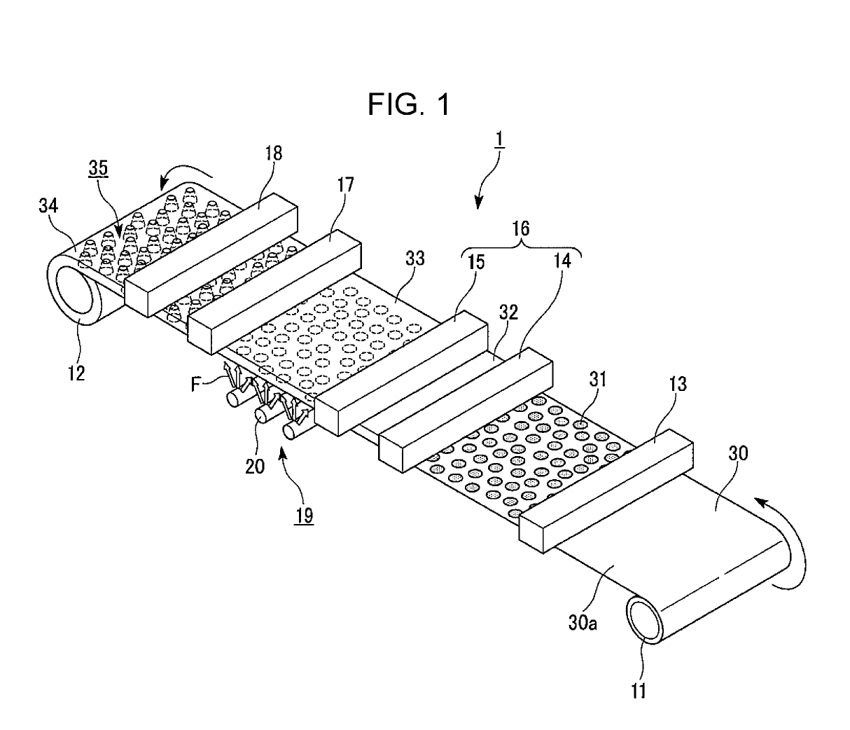

A first embodiment of a method for manufacturing a light-diffusing member and a light-diffusing member manufactured by the method for manufacturing the light-diffusing member will be described with reference to FIGS. 1 to 8.

FIG. 1 is a schematic configuration diagram showing an example of a device for manufacturing the light-diffusing member used in the method for manufacturing the light-diffusing member of the present embodiment.

A manufacturing apparatus 1 shown in FIG. 1 transfers an elongated substrate 30 in a roll-to-roll manner and performs various processes during the transfer. In the manufacturing apparatus 1, a printing method is used to form a light shielding layer 31.

As shown in FIG. 1, a supply roller 11 that supplies the substrate 30 is provided at one end of the manufacturing apparatus 1, and a winding roller 12 that winds the substrate 30 is provided at the other end thereof.

The substrate 30 moves toward the winding roller 12 from the supply roller 11. A printing device 13, a negative photosensitive resin layer forming device 16 which includes a barcode device 14 and a first drying device 15, a development device 17, and a second drying device 18 are sequentially arranged higher than the substrate 30 from the supply roller 11 toward the winding roller 12.

An exposure device 19 is arranged below the substrate 30.

The printing device 13 is configured to print the light shielding layer 31 made of a black resin on the substrate 30.

In a case where a light-diffusing section is formed using a negative photosensitive resin 32 having optical transparency, the barcode device 14 is configured to coat the light shielding layer 31 with the negative photosensitive resin 32 having optical transparency.

In the case where the light-diffusing section is formed using the negative photosensitive resin 32 having optical transparency, the first drying device 15 dries the coated negative photosensitive resin 32, and uses the dried resin as a coating film 33.

Although it has been described in the present embodiment that the negative photosensitive resin layer forming device 16 includes the barcode device 14 and the first drying device 15, the present embodiment is not limited thereto. In the present embodiment, in a case where the light-diffusing section is formed using a dry film resist, a laminating device which laminates the dry film resist on the substrate 30 is used as the negative photosensitive resin layer forming device 16.

The development device 17 is configured to develop the exposed negative photosensitive resin 32 (coating film 33) by using a developing solution.

The second drying device 18 is configured to dry the substrate 30 on which a light-diffusing section 34 made of the developed negative photosensitive resin 32 (the coating film 33) is formed.

The exposure device 19 is configured to expose the coating film 33 of the negative photosensitive resin 32 from a side close to the substrate 30. As shown in FIG. 1, the exposure device 19 includes light sources 20.

In the present embodiment, the light shielding layer 31 is initially formed on one surface 30a of the substrate 30 being transferred by the printing method using the printing device 13 (light shielding layer forming process).

The substrate 30 is generally formed using resins such as thermoplastic polymer, thermosetting resin and photo-polymeric resin. A substrate made of an appropriate transparent resin (optical transparency) such as acrylic polymer, olefin polymer, vinyl polymer, cellulose polymer, amide polymer, fluorine polymer, urethane polymer, silicone polymer, or imide polymer may be used.

As the substrate 30, for example, a substrate made of a transparent resin such as a triacetylcellulose (TAC) film, a polyethylene-telephthalate (PET) film, a cycloolefin polymer (COP) film, a polycarbonate (PC) film, a polyethyleneaphthalate (PEN) film, a polyether sulphone (PES) film, or a polyimide (PI) film is preferably used.

The substrate 30 serves as a base in a case where the materials of the light shielding layer 31 or the light-diffusing section 34 are coated, and needs to have heat resistance and mechanical strength in a heat treatment process during the manufacturing process. Accordingly, as the substrate 30, a substrate such as glass may be used in addition to the substrate made of resin.

Preferably, the substrate 30 has a thin thickness to the extent that heat resistance or mechanical strength is not impaired. This is because there is a concern that display may be blurred as the thickness of the substrate 30 becomes thicker. Preferably, the total light transmittance of the substrate 30 is 90% or more according to JIS K 7361-1. If the total light transmittance is 90% or more, sufficient transparency is obtained.

As shown in FIG. 1, the light shielding layer 31 is randomly formed on the one surface 30a of the substrate 30.

For example, the light shielding layer 31 is made of an organic material such as black resist having light absorptivity and photosensitivity. In addition, the light shielding layer 31 may be formed using black-based ink obtained by mixing metallic film such as a multilayer film made of Cr (chrome) or Cr/chromium oxide, pigments or dyes to be used in the black ink, and a multicolored ink. In addition to these materials, any material having light shielding properties may be used as the material of the light shielding layer 31.

For example, the thickness of the light shielding layer 31 is set to be smaller than a height from a light incident end surface up to a light emission end surface of the light-diffusing section 34.

Subsequently, the barcode device 14 coats the one surface 30a of the substrate 30 with the negative photosensitive resin 32 such that the light shielding layer 31 is covered, and the first drying device 15 dries the coated negative photosensitive resin 32 to form the coating film (hereinafter, referred to as a “negative photosensitive resin layer”) 33 (a negative photosensitive resin layer forming process).

For example, the negative photosensitive resin 32 is made of an organic material such as acrylic resin or epoxy resin having optical transparency and photosensitivity. In the present embodiment, preferably, the negative photosensitive resin 32 has the same refractive index as that of the substrate 30.

Thereafter, the exposure device 19 exposes the negative photosensitive resin layer 33 by irradiating the negative photosensitive resin layer 33 with parallel light F such as ultraviolet light diagonally with respect to a normal direction of the one surface 30a of the substrate 30 in two directions so as to allow the light to pass through the substrate 30 of a region other than a region where the shielding layer 31 is formed from a surface opposite to the one surface 30a of the substrate 30 on which the shielding layer 31 and the negative photosensitive resin layer 33 have been formed (a negative photosensitive resin layer exposing process).

Here, the process of exposing the negative photosensitive resin layer 33 in the present embodiment will be described.

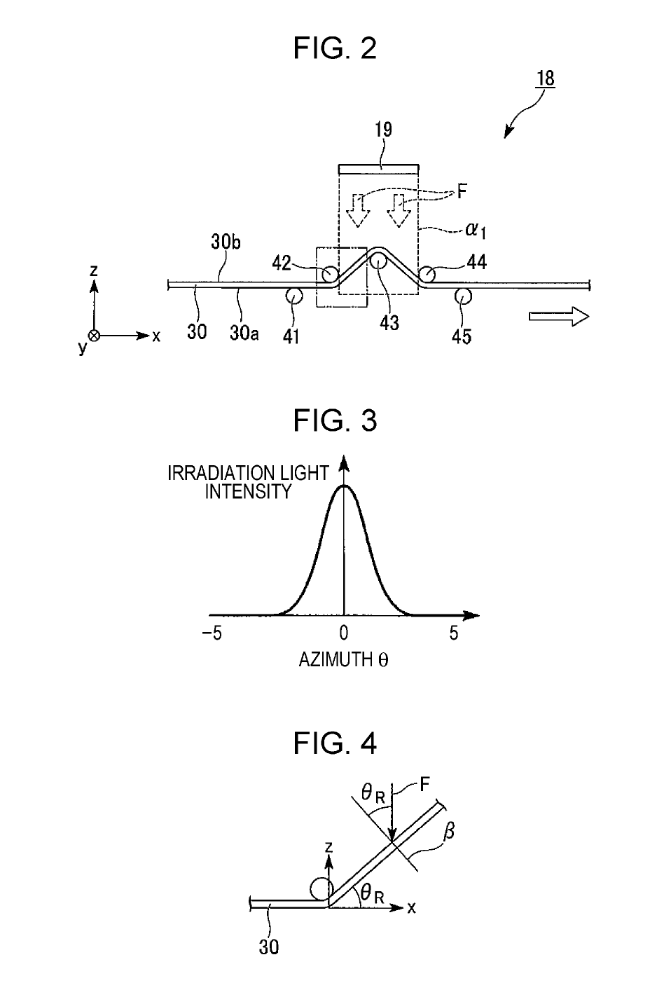

In the present embodiment, for example, the device having the configuration shown in FIG. 2 is used as the exposure device 19.

In FIG. 2, the light shielding layer 31 and the negative photosensitive resin layer 33 formed on the one surface 30a of the substrate 30 are omitted.

In FIG. 2, a direction (direction shown by an arrow of FIG. 2) in which the substrate 30 is transferred is referred to as an X-axis direction, a width direction of the substrate 30 is referred to as a Y-axis direction, and a height direction of the exposure device 19 is referred to as a Z-axis direction.

The exposure device 19 schematically includes the light sources 20 for irradiating the negative photosensitive resin layer 33 formed on the one surface 30a of the substrate 30 with the parallel light F such as the ultraviolet light, and a first roller 41, a second roller 42, a third roller 43, a fourth roller 44, and a fifth roller 45 which are arranged so as to correspond to a region (exposure region) α₁ where the negative photosensitive resin layer 33 can be exposed by the light sources 20 and sequentially support the substrate 30 in the transfer direction thereof.

The light sources 20 face the substrate 30, and are arranged so as to irradiate the substrate with the parallel light F perpendicular to the transfer direction (X-axis direction) of the substrate 30.

For example, an ultraviolet lamp is used as the light source 20.

Here, the parallel light F is light emitted with a full width at a half maximum of ±2 degrees or less and high intensity at which azimuth is 0 degrees, and is, for example, light having distribution characteristics as shown in FIG. 3.

The first roller 41 is arranged on the one surface 30a of the substrate 30 on a supply side of the substrate 30, and supports the substrate 30.

The second roller 42 is arranged in the transfer direction of the substrate 30 with a prescribed distance from the first roller 41, is arranged on the surface (the other surface of the substrate 30) 30b opposite to the one surface 30a of the substrate 30, and supports the substrate 30. The second roller 42 is arranged near one end (end on the supply side of the substrate 30) of the exposure region α₁.

The third roller 43 is arranged in the transfer direction of the substrate 30 with a prescribed distance from the second roller 42 and the fourth roller 44, is arranged on the one surface 30a of the substrate 30 in the center of the exposure region α₁, and supports the substrate 30. The third roller 43 moves in the Z-axis direction, and is arranged higher than the first roller 41, the second roller 42, the fourth roller 44 and the fifth roller 45 in the Z-axis direction.

The fourth roller 44 is arranged in the transfer direction of the substrate 30 with a prescribed distance from the third roller 43, is arranged on the other surface 30b of the substrate 30, and supports the substrate 30. The fourth roller 44 is arranged near the other end (end on a winding side of the substrate 30) of the exposure region α₁.

The fifth roller 45 is arranged in the transfer direction of the substrate 30 with a prescribed distance from the fourth roller 44, is arranged on the one surface 30a of the substrate 30, and supports the substrate 30, on the winding side of the substrate 30.

In the process of exposing the negative photosensitive resin layer 33, the position of the third roller 43 moves upward in the Z-axis direction (higher than the first roller 41, the second roller 42, the fourth roller 44 and the fifth roller 45 in the Z-axis direction), and thus, it is possible to allow the substrate 30 being transferred in the X-axis direction to have an arbitrary inclined angle θ_{R} with respect to the X-axis direction, as shown in FIG. 4. In FIG. 4, a normal line of the substrate 30 is expressed by symbol β.

In such a state, the parallel light F emitted from the light source 20 is incident at an inclined angle ±θ_{R} inclined with respect to the normal direction of the substrate 30. For example, in a case where an inclined angle (incident angle) of the second roller 42 is +θ_{R} with the third roller 43 as its center, it is assumed that an inclined angle (incident angle) of the fourth roller 44 is −θ_{R}. By arranging the third roller 43 that moves in the Z-axis direction within the exposure region α₁ in the center of the exposure region α₁, the amount of irradiated parallel light F at the inclined angle +θ_{R} of the second roller 42 and the amount of irradiated parallel light at the inclined angle −θ_{R} of the fourth roller 44 can be equal to each other.

As mentioned above, since the parallel light F is applied from the other surface 30b (the surface opposite to the surface of the substrate 30 on which the light shielding layer 31 and the negative photosensitive resin layer 33 are formed) in a state in which the substrate 30 is inclined in the X-axis direction, that is, in a state in which the substrate has the inclined angle with respect to the normal direction, the region of the substrate 30 other than the normal direction can be irradiated with the high-intensity parallel light.

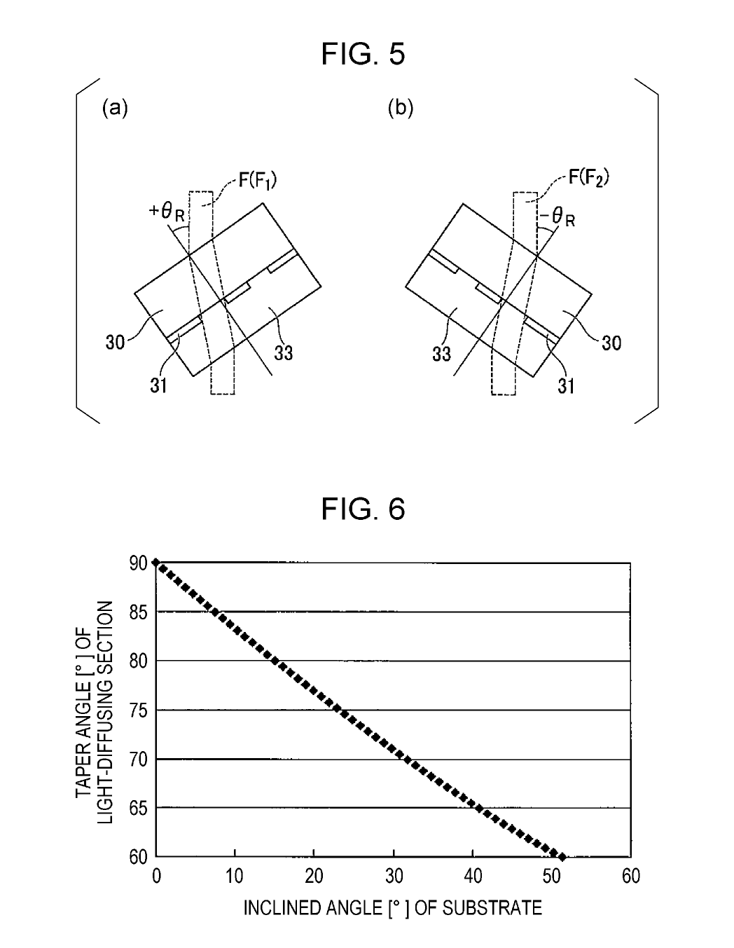

More specifically, the parallel light F applied to the substrate 30 from the light source 20 is incident diagonally with respect to the normal direction of the substrate 30, as shown in FIG. 5. The parallel light F is refracted in a case where the parallel light is incident on the substrate 30 from the air, and transmits through the negative photosensitive resin layer 33 at a refracted angle at the time of being incident on the substrate 30. Thereafter, the parallel light F is emitted while being refracted from the negative photosensitive resin layer 33 to the air. FIG. 5(a) is a diagram showing a traveling state of the parallel light F on the second roller 42 side, and FIG. 5(b) is a diagram showing a traveling state of the parallel light F on the fourth roller 44 side.

As stated above, by moving the position of the third roller 43 in the Z-axis direction and allowing the substrate 30 to have an arbitrary inclined angle with respect to the normal direction thereof, since the parallel light F emitted from the light source 20 can be incident so as to be inclined with respect to the normal direction of the substrate 30, a taper angle of the negative photosensitive resin layer 33 (light-diffusing section 34) can be adjusted by the inclined angle (the inclined angle with respect to the X-axis direction) of the substrate 30. As shown in FIG. 6, the taper angle of the light-diffusing section 34 and the inclined angle of the substrate 30 are substantially inverse in proportion to each other.

For example, it is assumed that a refractive index with which ultraviolet light (wavelength: 365 nm) is refracted from the substrate 30 and the negative photosensitive resin layer 33 is n=1.5. For example, in a case where the taper angle of the light-diffusing section 34 of the light-diffusing member needs to be 80 degrees, the negative photosensitive resin layer 33 may be exposed by setting the inclined angle (the inclined angle θ_{R}) with respect to the X-axis direction of the substrate 30 to be 15 degrees and irradiating the substrate 30 and the negative photosensitive resin layer 33 with the parallel light F. Preferably, the taper angle of the light-diffusing section 34 is 60 degrees or more and less than 90 degrees. For example, as shown in FIG. 6, by setting the inclined angle with respect to the X-axis direction of the substrate 30, that is, the inclined angle of the parallel light F with respect to the normal direction of the substrate 30 to be 50 degrees, it is possible to set the taper angle of the light-diffusing section 34 to be 60 degrees. In the present embodiment, in order to set the taper angle of the light-diffusing section 34 to be 60 degrees or more and less than 90 degrees, the incident angle of the parallel light F with respect to the normal direction of the substrate 30 may be changed within a range of ±50 degrees.

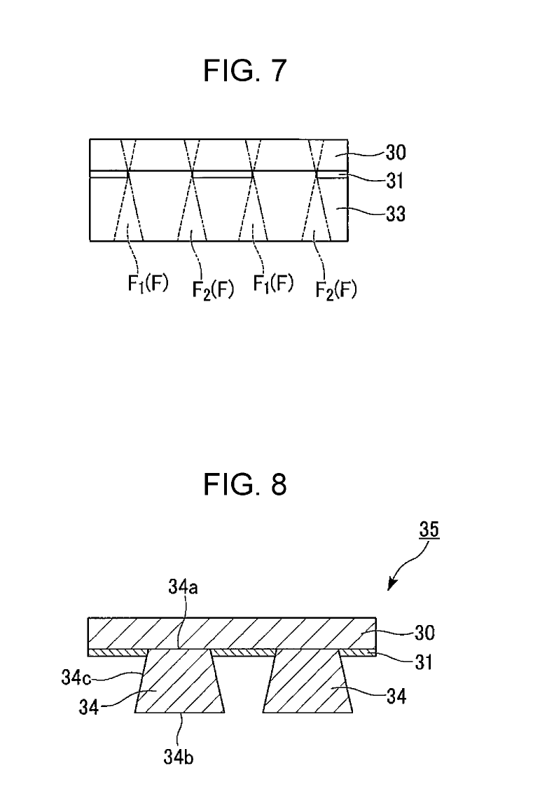

For example, since the parallel light F (F₁) is incident with respect to the normal direction of the substrate 30 at the incident angle +θ_{R} on the second roller 42 side as shown in FIG. 5(a), the parallel light F₁ travels in the negative photosensitive resin layer 33 while being inclined toward the supply side of the substrate 30 as shown in FIG. 7. Meanwhile, for example, since the parallel light F (F₂) is incident with respect to the normal direction of the substrate 30 at the inclined angle −θ_{R} on the fourth roller 44 side as shown in FIG. 5(b), the parallel light F₂ travels in the negative photosensitive resin layer 33 while being inclined toward the winding side of the substrate 30 as shown in FIG. 7.

As described above, according to the present embodiment, it is possible to expose the negative photosensitive resin layer 33 in two different directions by using the parallel light F, as shown in FIG. 7. The negative photosensitive resin layer 33 is exposed on the section (section of the substrate 30 in the normal direction) shown in FIG. 7 so as to be bilaterally symmetrical.

Subsequently, the development device 17 develops the exposed negative photosensitive resin layer 33, and the second drying device 18 forms the light-diffusing section 34 having a light emission end surface 34a on a side close to the substrate 30 and a light incident end surface 34b having an area greater than an area of the light emission end surface 34a on a side opposite to the substrate 30 on the one surface 30a of the substrate 30 as shown in FIG. 8 (a light-diffusing section forming process).

Thereafter, a light-diffusing member 35 is obtained by drying the substrate 30 formed on the light-diffusing section 34.

As shown in FIG. 8, the light-diffusing section 34 is formed such that the area of the light emission end surface 34a is small and a sectional area in a horizontal direction escalates as the cross section area becomes further away from the substrate 30 when viewed as a whole.

That is, the light-diffusing section 34 has a quadrangular pyramid shape of a so-called reverse taper shape when viewed from the substrate 30. The light emission end surface 34a and the light incident end surface 34b of the light-diffusing section 34 are formed in parallel with each other. Angles (taper angles) of taper-shaped side surfaces 34c of the light-diffusing section 34 are bilaterally symmetrical on the section (section of the substrate 30 in the normal direction) shown in FIG. 8.

Such a light-diffusing section 34 is a section of the light-diffusing member 35 which contributes to light transmission. That is, the light incident on the light-diffusing section 34 from the light incident end surface 34b is totally reflected from the taper-shaped side surfaces 34c of the light-diffusing section 34, and is guided while being substantially confined within the light-diffusing section 34, and is emitted from the light emission end surface 34a.

### (2) Second Embodiment

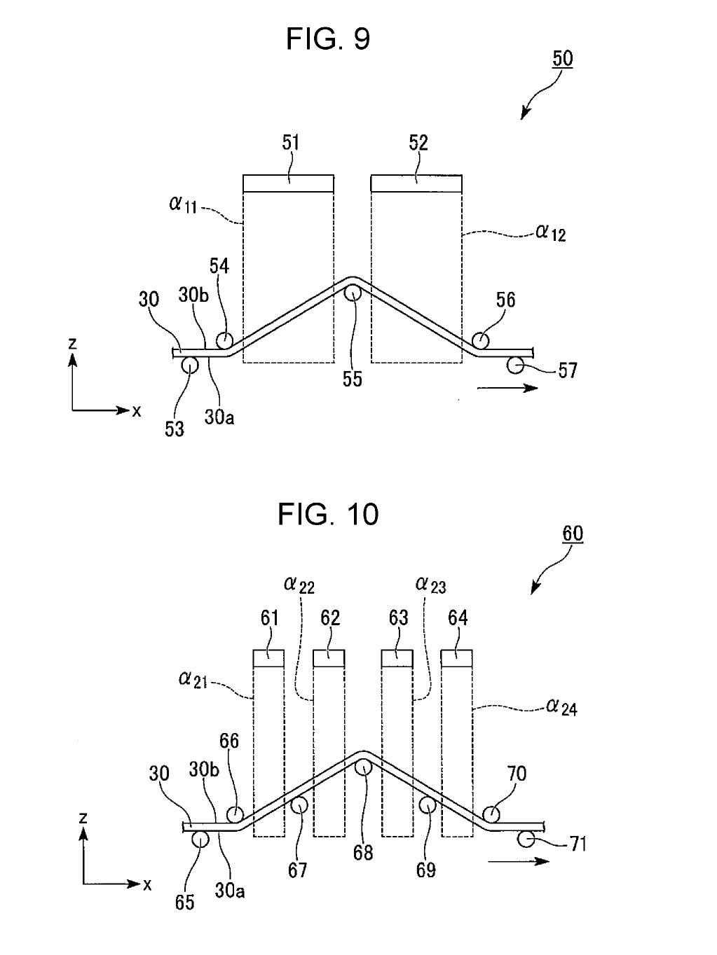

A second embodiment of the method for manufacturing the light-diffusing member will be described with reference to FIG. 9.

The method for manufacturing the light-diffusing member of the present embodiment is different from the method for manufacturing the light-diffusing member of the above-described first embodiment in that an exposure device 50 shown in FIG. 9 is used as the exposure device in the process of exposing the negative photosensitive resin layer 33. Other processes are the same as those in the method for manufacturing the light-diffusing member of the above-described first embodiment.

In FIG. 9, the same components as those shown in FIG. 2 will be assigned the same reference numerals, and the description thereof will be omitted. In FIG. 9, the light shielding layer 31 and the negative photosensitive resin layer 33 formed on the one surface 30a of the substrate 30 will be omitted.

In FIG. 9, a direction (direction shown by an arrow in FIG. 9) in which the substrate 30 is transferred is referred to as an X-axis direction, a width direction of the substrate 30 is referred to as a Y-axis direction, and a height direction of the exposure device 50 is referred to as a Z-axis direction.

The exposure device 50 schematically includes two light sources 51 and 52 for irradiating the negative photosensitive resin layer 33 formed on the one surface 30a of the substrate 30 with the parallel light F such as ultraviolet light, and a first roller 53, a second roller 54, a third roller 55, a fourth roller 56 and a fifth roller 57 which are arranged so as to correspond to two regions (exposure regions) α₁₁ and α₁₂ where the negative photosensitive resin layer 33 can be exposed by the light sources 51 and 52 and sequentially support the substrate 30 in the transfer direction.

The light sources 51 and 52 face the substrate 30, and are arranged in positions which are positioned in the transfer direction (X-axis direction) of the substrate 30 and are symmetrical with respect to the third roller 55. The light sources 51 and 52 are arranged so as to irradiate the substrate 30 with the parallel light F in a direction perpendicular to the transfer direction (X-axis direction) thereof.

For example, ultraviolet lamps are used as the light sources 51 and 52.

The first roller 53 is arranged on the one surface 30a of the substrate 30 and supports the substrate 30 on the supply side of the substrate 30.

The second roller 54 is arranged in the transfer direction of the substrate 30 with a prescribed distance from the first roller 53 and the third roller 55, is arranged on the other surface 30b of the substrate 30, and supports the substrate 30.

The second roller 54 is arranged near one end (end on the supply side of the substrate 30) of the exposure region α₁₁ on the supply side of the substrate 30.

The third roller 55 is arranged in the transfer direction of the substrate 30 with a prescribed distance from the second roller 54 and the fourth roller 56, is arranged on the one surface 30a of the substrate 30, and supports the substrate 30. The third roller 55 is arranged near the other end (end on the winding side of the substrate 30) of the exposure region α₁₁ on the supply side of the substrate 30 and near one end (end on the supply side of the substrate 30) of the exposure region α₁₂ on the winding side of the substrate 30. The third roller 55 is arranged in an intermediate portion between the second roller 54 and the fourth roller 56. The third roller 55 moves in the Z-axis direction, and is arranged higher than the first roller 53, the second roller 54, the fourth roller 56 and the fifth roller 57 in the Z-axis direction.

The fourth roller 56 is arranged in the transfer direction of the substrate 30 with a prescribed distance from the third roller 55 and the fifth roller 57, is arranged on the other surface 30b of the substrate 30, and supports the substrate 30. The fourth roller 56 is arranged near the other end (end on the winding side of the substrate 30) of the exposure region α₁₂ on the winding side of the substrate 30.

The fifth roller 57 is arranged in the transfer direction of the substrate 30 with a prescribed distance from the fourth roller 56, and is arranged on the one surface 30a of the substrate 30 and supports the substrate 30 on the winding side of the substrate 30.

That is, the exposure region α₁₁ on the supply side of the substrate 30 is formed between the second roller 54 and the third roller 55, and the exposure region α₁₂ on the winding side of the substrate 30 is formed between the third roller 55 and the fourth roller 56.

In the process of exposing the negative photosensitive resin layer 33, the position of the third roller 55 moves upward in the Z-axis direction (higher than the first roller 53, the second roller 54, the fourth roller 56 and the fifth roller 57 in the Z-axis direction), and thus, it is possible to allow the substrate 30 to have an arbitrary inclined angle with respect to the X-axis direction, similarly to the method for manufacturing the light-diffusing member of the above-described first embodiment. Accordingly, it is possible to apply the parallel light F from the other surface 30b in a state in which the normal direction of the substrate 30 has the inclined angle with respect to the normal direction.

According to the present embodiment, since the exposure region α₁₁ on the supply side of the substrate 30 is formed between the second roller 54 and the third roller 55 and the exposure region α₁₂ on the winding side of the substrate 30 is formed between the third roller 55 and the fourth roller 56 by arranging two light sources 51 and 52 in the positions symmetrical with respect to the third roller 55, the parallel light F having a prescribed intensity can be incident on the negative photosensitive resin layer 33 formed on the one surface 30a of the substrate 30 without shielding the parallel light emitted from the light sources 51 and 52 by the first roller 53, the second roller 54, the third roller 55, the fourth roller 56 and the fifth roller 57 provided in the exposure device 50. Thus, it is possible to form the light-diffusing section 34 having a prescribed taper angle. According to the present embodiment, it is possible to expose the negative photosensitive resin layer 33 by using the parallel light F in two different directions.

According to the present embodiment, the light-diffusing member 35 on which the same light-diffusing section 34 as that of the above-described first embodiment is formed is obtained.

### (3) Third Embodiment

A third embodiment of the method for manufacturing the light-diffusing member will be described with reference to FIG. 10.

The method for manufacturing the light-diffusing member of the present embodiment is different from the method for manufacturing the light-diffusing member of the above-described first embodiment in that an exposure device 60 shown in FIG. 10 is used as the exposure device in the process of exposing the negative photosensitive resin layer 33. Other processes are the same as those in the method for manufacturing the light-diffusing member of the above-described first embodiment.

In FIG. 10, the same components as those shown in FIG. 2 will be assigned the same reference numerals, and the description thereof will be omitted. In FIG. 10, the light shielding layer 31 and the negative photosensitive resin layer 33 formed on the one surface 30a of the substrate 30 will be omitted.

In FIG. 10, a direction (direction shown by an arrow in FIG. 10) in which the substrate 30 is transferred is referred to as an X-axis direction, a width direction of the substrate 30 is referred to as a Y-axis direction, and a height direction of the exposure device 50 is referred to as a Z-axis direction.

The exposure device 60 schematically includes four light sources 61, 62, 63 and 64 for irradiating the negative photosensitive resin layer 33 formed on the one surface 30a of the substrate 30 with the parallel light F such as the ultraviolet light, and a first roller 65, a second roller 66, a third roller 67, a fourth roller 68, a fifth roller 69, a sixth roller 70 and a seventh roller 71 which correspond to four regions (exposure regions) α₂₁, α₂₂, α₂₃ and α₂₄ (hereinafter, respectively referred to as “a first exposure region α₂₁, a second exposure region α₂₂, a third exposure region α₂₃, and a fourth exposure region α₂₄”) where the negative photosensitive resin layer 33 can be exposed by the light sources 61, 62, 63 and 64 and sequentially support the substrate 30 in the transfer direction thereof.

A group of light sources 61 and 62 and a group of light sources 63 and 64 face the substrate 30, and are arranged in positions which are positioned in the transfer direction (X-axis direction) of the substrate 30 and are symmetrical with respect to the fourth roller 68. The light sources 61, 62, 63 and 64 are arranged so as to irradiate the substrate 30 with the parallel light F in a direction perpendicular to the transfer direction (X-axis direction) of the substrate.

For example, ultraviolet lamps are sued as the light sources 61, 62, 63 and 64.

The first roller 65 is arranged on the one surface 30a of the substrate 30 and supports the substrate 30 on the supply side of the substrate 30.

The second roller 66 is arranged in the transfer direction of the substrate 30 with a prescribed distance from the first roller 65 and the third roller 67, is arranged on the other surface 30b of the substrate 30, and supports the substrate 30. The second roller 66 is arranged near one end (end on the supply side of the substrate 30) of the first exposure region α₂₁.

The third roller 67 is arranged in the transfer direction of the substrate 30 with a prescribed distance from the second roller 66 and the fourth roller 68, is arranged on the one surface 30a of the substrate 30, and supports the substrate 30. The third roller 67 is arranged near the other end (end on the winding side of the substrate 30) of the first exposure region α₂₁ and near one end (end on the supply side of the substrate 30) of the second exposure region α₂₂.

The fourth roller 68 is arranged in the transfer direction of the substrate 30 with a prescribed distance from the third roller 67 and the fifth roller 69, is arranged on the one surface 30a of the substrate 30, and supports the substrate 30. The fourth roller 68 is arranged near the other end (end on the winding side of the substrate 30) of the second exposure region α₂₂ and near one end (end on the supply side of the substrate 30) of the third exposure region α₂₃. The fourth roller 68 is arranged in an intermediate portion between the third roller 67 and the fifth roller 69. The fourth roller 68 moves in the Z-axis direction, and is arranged higher than the first roller 65, the second roller 66, the third roller 67, the fifth roller 69, the sixth roller 70 and the seventh roller 71 in the Z-axis direction.

The fifth roller 69 is arranged in the transfer direction of the substrate 30 with a prescribed distance from the fourth roller 68 and the sixth roller 70, is arranged on the one surface 30a of the substrate 30, and supports the substrate 30. The fifth roller 69 is arranged near the other end (end on the winding side of the substrate 30) of the third exposure region α₂₃ and near one end (end on the supply side of the substrate 30) of the fourth exposure region α₂₄.

The sixth roller 70 is arranged in the transfer direction of the substrate 30 with a prescribed distance from the fifth roller 69 and the seventh roller 71, is arranged on the other surface 30b of the substrate 30, and supports the substrate 30. The sixth roller 70 is arranged near the other end (end on the winding side of the substrate 30) of the fourth exposure region α₂₄.

The seventh roller 71 is arranged in the transfer direction of the substrate 30 with a prescribed distance from the sixth roller 70, and is arranged on one surface 30a of the substrate 30 and supports the substrate 30 on the winding side of the substrate 30.

That is, the first exposure region α₂₁ is formed between the second roller 66 and the third roller 67, the second exposure region α₂₂ is formed between the third roller 67 and the fourth roller 68, the third exposure region α₂₃ is formed between the fourth roller 68 and the fifth roller 69, and the fourth exposure region α₂₄ is formed between the fifth roller 69 and the sixth roller 70.

In the process of exposing the negative photosensitive resin layer 33, the position of the fourth roller 68 moves upwards (higher than the first roller 65, the second roller 66, the third roller 67, the fifth roller 69, the sixth roller 70 and the seventh roller 71 in the Z-axis direction) in the Z-axis direction, and thus, the substrate 30 can have an arbitrary inclined angle with respect to the X-axis direction, similarly to the method for manufacturing the light-diffusing member of the above-described first embodiment. Accordingly, the parallel light F can be applied from the other surface 30b in a state in which the substrate 30 has the inclined angle with respect to the normal direction.

According to the present embodiment, since the first exposure region α₂₁ is formed between the second roller 66 and the third roller 67, the second exposure region α₂₂ is formed between the third roller 67 and the fourth roller 68, the third exposure region α₂₃ is formed between the fourth roller 68 and the fifth roller 69, and the fourth exposure region α₂₄ is formed between the fifth roller 69 and the sixth roller 70 by arranging the group of two light sources 61 and 62 and the group of two light sources 63 and 64 in the positions symmetrical with respect to the fourth roller 68, the parallel light F having a prescribed intensity can be incident on the negative photosensitive resin layer 33 formed on the one surface 30a of the substrate 30 without shielding the parallel light emitted from light sources 61, 62, 63 and 64 by the first roller 65, the second roller 66, the third roller 67, the fourth roller 68, the fifth roller 69, the sixth roller 70 and the seventh roller 71 provided in the exposure device 60. Accordingly, it is possible to form the light-diffusing section 34 having a prescribed taper angle. According to the present embodiment, it is possible to expose the negative photosensitive resin layer 33 by using the parallel light F in two different directions.

According to the present embodiment, the light-diffusing member 35 on which the same light-diffusing section 34 as that of the above-described first embodiment is formed is obtained.

### (4) Fourth Embodiment

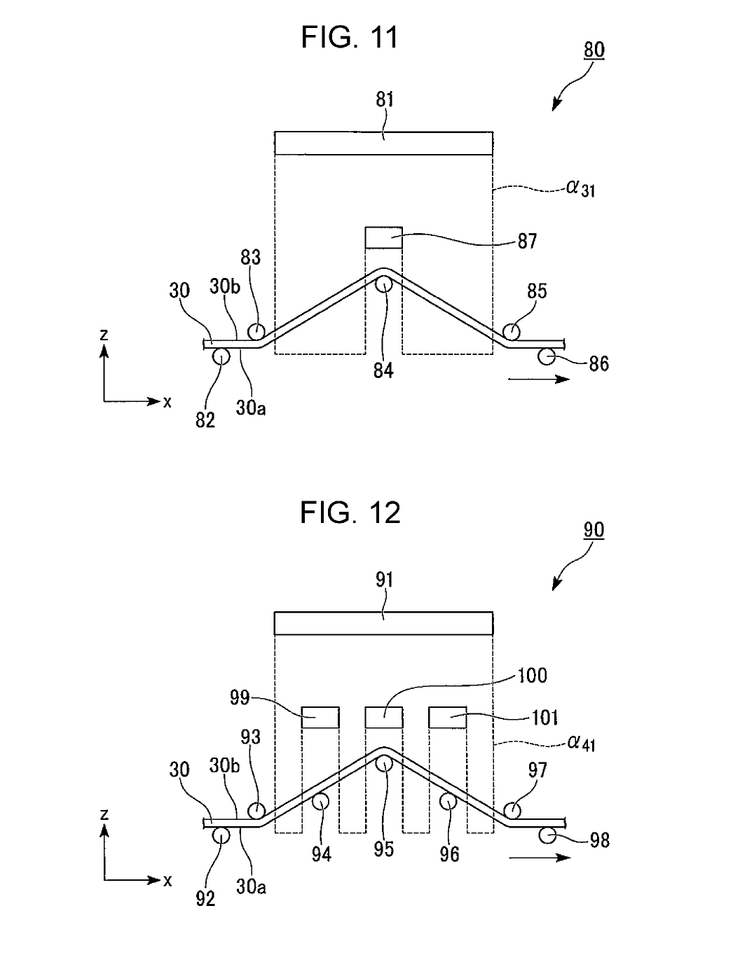

A fourth embodiment of the method for manufacturing the light-diffusing member will be described with reference to FIG. 11.

The method for manufacturing the light-diffusing member of the present embodiment is different from the method for manufacturing the light-diffusing member of the above-described first embodiment in that an exposure device 80 shown in FIG. 11 is used as the exposure device in the process of exposing the negative photosensitive resin layer 33. Other processes are the same as those in the method for manufacturing the light-diffusing member of the above-described first embodiment.

In FIG. 11, the same components as those shown in FIG. 2 will be assigned the same reference numerals, and the description thereof will be omitted. In FIG. 11, the light shielding layer 31 and the negative photosensitive resin layer 33 formed on the one surface 30a of the substrate 30 will be omitted.

In FIG. 11, a direction (direction shown by an arrow in FIG. 11) in which the substrate 30 is transferred is referred to as an X-axis direction, a width direction of the substrate 30 is referred to as a Y-axis direction, and a height direction of the exposure device 80 is referred to as a Z-axis direction.

The exposure device 80 schematically includes a light source 81 for irradiating the negative photosensitive resin layer 33 formed on the one surface 30a of the substrate 30 with the parallel light F such as the ultraviolet light, and a first roller 82, a second roller 83, a third roller 84, a fourth roller 85 and a fifth roller 86 which are arranged so as to correspond to a region (exposure region) α₃₁ where the negative photosensitive resin layer 33 can be exposed by the light source 81 and sequentially support the substrate 30 in the transfer direction thereof, and a light shielding section 87 arranged between the light source 81 and the third roller 84.

The light source 81 is arranged so as to irradiate the substrate 30 with the parallel light in a direction perpendicular to the transfer direction (X-axis direction) of the substrate 30.

For example, an ultraviolet lamp is used as the light source 81.

The first roller 82 is arranged on the one surface 30a of the substrate 30 and supports the substrate 30 on the supply side of the substrate 30.

The second roller 83 is arranged in the transfer direction of the substrate 30 with a prescribed distance from the first roller 82 and the third roller 84, is arranged on the other surface 30b of the substrate 30, and supports the substrate 30. The second roller 83 is arranged near one end (end on the supply side of the substrate 30) of the exposure region α₃₁ of the substrate 30.

The third roller 84 is arranged in the transfer direction of the substrate 30 with a prescribed distance from the second roller 83 and the fourth roller 85, is arranged on the one surface 30a of the substrate 30, and supports the substrate 30. The third roller 84 is arranged in an intermediate portion between the second roller 83 and the fourth roller 85. The third roller 84 moves in the Z-axis direction, and is arranged higher than the first roller 82, the second roller 83, the fourth roller 85, and the fifth roller 86 in the Z-axis direction.

The fourth roller 85 is arranged in the transfer direction of the substrate 30 with a prescribed distance from the third roller 84 and the fifth roller 86, is arranged on the other surface 30b of the substrate 30, and supports the substrate 30. The fourth roller 85 is arranged near the other end (end on the winding side of the substrate 30) of the exposure region α₃₁ of the substrate 30.

The fifth roller 86 is arranged in the transfer direction of the substrate 30 with a prescribed distance from the fourth roller 85, and is arranged on the one surface 30a of the substrate 30 and supports the substrate 30 on the winding side of the substrate 30.

The light shielding section 87 is arranged between the light source 81 and the third roller 84 in parallel with the transfer direction (X-axis direction) of the substrate 30. The parallel light F emitted from the light source 81 is shielded by the light shielding section 87, and a region below the light shielding section 87 in the Z-axis direction is not irradiated with the parallel light F. That is, the third roller 84 and the substrate 30 present near the third roller is not irradiated with the parallel light F emitted from the light source 81 by the light shielding section 87.

In the process of exposing the negative photosensitive resin layer 33, the position of the third roller 84 moves upward in the Z-axis direction (higher than the first roller 82, the second roller 83, the fourth roller 85 and the fifth roller 86 in the Z-axis direction), and thus, the substrate 30 can have an arbitrary inclined angle with respect to the X-axis direction, similarly to the method for manufacturing the light-diffusing member of the above-described first embodiment. Accordingly, it is possible to apply the parallel light F from the other surface 30b in a state in which the normal direction of the substrate 30 has the inclined angle with respect to the normal direction.

According to the present embodiment, since the light shielding section 87 is arranged between the light source 81 and the third roller 84 in parallel with the transfer direction (X-axis direction) of the substrate 30, the parallel light F emitted from the light source 81 is shielded by the light shielding section 87, and the region below the light shielding section 87 in the Z-axis direction is not irradiated with the parallel light F. Accordingly, the parallel light F emitted from the light source 81 is shielded by the third roller 84, and thus, it is possible to prevent a problem that the parallel light having a prescribed intensity is not incident on the negative photosensitive resin layer 33 formed on the one surface 30a of the substrate 30. Therefore, it is possible to form the light-diffusing section 34 having a prescribed taper angle. According to the present embodiment, it is possible to expose the negative photosensitive resin layer 33 by the parallel light F in two different directions.

According to the present embodiment, the light-diffusing member 35 on which the same light-diffusing section 34 as that of the above-described first embodiment is formed is obtained.

### (5) Fifth Embodiment

A fifth embodiment of the method for manufacturing the light-diffusing member will be described with reference to FIG. 12.

The method for manufacturing the light-diffusing member of the present embodiment is different from the method for manufacturing the light-diffusing member of the above-described first embodiment in that an exposure device 90 shown in FIG. 12 is used as the exposure device in the process of exposing the negative photosensitive resin layer 33. Other processes are the same as those in the method for manufacturing the light-diffusing member of the above-described first embodiment.

In FIG. 12, the same components as those shown in FIG. 2 will be assigned the same reference numerals, and the description thereof will be omitted. In FIG. 12, the light shielding layer 31 and the negative photosensitive resin layer 33 formed on the one surface 30a of the substrate 30 will be omitted.

In FIG. 12, a direction (direction shown by an arrow in FIG. 12) in which the substrate 30 is transferred is referred to as an X-axis direction, a width direction of the substrate 30 is referred to as a Y-axis direction, and a height direction of the exposure device 90 is referred to as a Z-axis direction.

The exposure device 90 schematically includes a light source 91 for irradiating the negative photosensitive resin layer 33 formed on the one surface 30a of the substrate 30 with the parallel light F such as ultraviolet light, a first roller 92, a second roller 93, a third roller 94, a fourth roller 95, a fifth roller 96, a sixth roller 97, and a seventh roller 98 which are arranged so as to correspond to a region (exposure region) α₄₁ where the negative photosensitive resin layer 33 can be exposed by the light source 91 and sequentially support the substrate 30 in the transfer direction thereof, a first light shielding section 99 disposed between the light source 91 and the third roller 94, a second light shielding section 100 disposed between the light source 91 and the fourth roller 95, and a third light shielding section 101 disposed between the light source 91 and the fifth roller 96.

The light source 91 faces the substrate 30, and is arranged so as to irradiate the substrate 30 with the parallel light in a direction perpendicular to the transfer direction (X-axis direction) thereof.

For example, an ultraviolet lamp is used as the light source 91.

The first roller 92 is arranged on the one surface 30a of the substrate 30 and supports the substrate 30 on the supply side of the substrate 30.

The second roller 93 is arranged in the transfer direction of the substrate 30 with a prescribed distance from the first roller 92 and the third roller 94, is arranged on the other surface 30b of the substrate 30, and supports the substrate 30. The second roller 93 is arranged near one end (end on the supply side of the substrate 30) of the exposure region α₄₁ of the substrate 30.

The third roller 94 is arranged in the transfer direction of the substrate 30 with a prescribed distance from the second roller 93 and the fourth roller 95, is arranged on the one surface 30a of the substrate 30, and supports the substrate 30.

The fourth roller 95 is arranged in the transfer direction of the substrate 30 with a prescribed distance from the third roller 94 and the fifth roller 96, is arranged on the one surface 30a of the substrate 30, and supports the substrate 30. The fourth roller 95 is arranged in an intermediate portion between the third roller 94 and the fifth roller 96. The fourth roller 95 moves in the Z-axis direction, and is arranged higher than the first roller 92, the second roller 93, the third roller 94, the fifth roller 96, the sixth roller 97 and the seventh roller 98 in the Z-axis direction.

The fifth roller 96 is arranged in the transfer direction of the substrate 30 with a prescribed distance from the fourth roller 95 and the sixth roller 97, is arranged on the one surface 30a of the substrate 30, and supports the substrate 30.

The sixth roller 97 is arranged in the transfer direction of the substrate 30 with a prescribed distance from the fifth roller 96 and the seventh roller 98, is arranged on the other surface 30b of the substrate 30, and supports the substrate 30. The sixth roller 97 is arranged near the other end (end on the winding side of the substrate 30) of the exposure region α₄₁ of the substrate 30.

The seventh roller 98 is arranged in the transfer direction of the substrate 30 with a prescribed distance from the sixth roller 97, and is arranged on the one surface 30a of the substrate 30 and supports the substrate 30 on the winding side of the substrate 30.

The first light shielding section 99 is arranged between the light source 91 and the third roller 94 in parallel with the transfer direction (X-axis direction) of the substrate 30. The parallel light F emitted from the light source 91 is shielded by the first light shielding section 99, and a region below the first light shielding section 99 in the Z-axis direction is not irradiated with the parallel light F. That is, the third roller 94 and the substrate 30 near the third roller are not irradiated with the parallel light F emitted from the light source 91 by the first light shielding section 99.

The second light shielding section 100 is arranged between the light source 91 and the fourth roller 95 in parallel with the transfer direction (X-axis direction) of the substrate 30. The parallel light F emitted from the light source 91 is shielded by the second light shielding section 100, and a region below the second light shielding section 100 in the Z-axis direction is not irradiated with the parallel light F. That is, the fourth roller 95 and the substrate 30 near the fourth roller are not irradiated with the parallel light F emitted from the light source 91 by the second light shielding section 100.

The third light shielding section 101 is arranged between the light source 91 and the fifth roller 96 in parallel with the transfer direction (X-axis direction) of the substrate 30. The parallel light F emitted from the light source 91 is shielded by the third light shielding section 101, and a region below the third light shielding section 101 in the Z-axis direction is not irradiated with the parallel light F. That is, the fifth roller 96 and the substrate 30 near the fifth roller are not irradiated with the parallel light F emitted from the light source 91 by the third light shielding section 101.

In the process of exposing the negative photosensitive resin layer 33, the position of the fourth roller 95 moves upwards (higher than the first roller 92, the second roller 93, the third roller 94, the fifth roller 96, the sixth roller 97 and the seventh roller 98 in the Z-axis direction) in the Z-axis direction, and thus, the substrate 30 can have an arbitrary inclined angle with respect to the X-axis direction, similarly to the method for manufacturing the light-diffusing member of the above-described first embodiment. Accordingly, the parallel light F can be applied from the other surface 30b in a state in which the substrate 30 has the inclined angle with respect to the normal direction.

According to the present embodiment, since the first light shielding section 99 is arranged between the light source 91 and the third roller 94 in parallel with the transfer direction (X-axis direction) of the substrate 30, the parallel light F emitted from the light source 91 is shielded by the first light shielding section 99, and the region below the first light shielding section 99 in the Z-axis direction is not irradiated with the parallel light F. Accordingly, the parallel light F emitted from the light source 91 is shielded by the third roller 94, and thus, it is possible to prevent a problem that the parallel light having a prescribed intensity is not incident on the negative photosensitive resin layer 33 formed on the one surface 30a of the substrate 30. Since the second light shielding section 100 is arranged between the light source 91 and the fourth roller 95 in parallel with the transfer direction (X-axis direction) of the substrate 30, the parallel light F emitted from the light source 91 is shielded by the second light shielding section 100, and the region below the second light-shielding section 100 in the Z-axis direction is not irradiated with the parallel light F. Accordingly, the parallel light F emitted from the light source 91 is shielded by the fourth roller 95, and thus, it is possible to prevent a problem that the parallel light having a prescribed intensity is not incident on the negative photosensitive resin layer 33 formed on the one surface 30a of the substrate 30. Since the third light shielding section 101 is arranged between the light source 91 and the fifth roller 96 in parallel with the transfer direction (X-axis direction) of the substrate 30, the parallel light F emitted from the light source 91 is shielded by the third light shielding section 101, and the region below the third light-shielding section 101 in the Z-axis direction is not irradiated with the parallel light F. Accordingly, the parallel light F emitted from the light source 91 is shielded by the fifth roller 96, and thus, it is possible to prevent a problem that the parallel light having a prescribed intensity is not incident on the negative photosensitive resin layer 33 formed on the one surface 30a of the substrate 30. Therefore, it is possible to form the light-diffusing section 34 having a prescribed taper angle. According to the present embodiment, it is possible to expose the negative photosensitive resin layer 33 by the parallel light F in two different directions.

According to the present embodiment, the light-diffusing member 35 on which the same light-diffusing section 34 as that of the above-described first embodiment is formed is obtained.

### (6) Sixth Embodiment

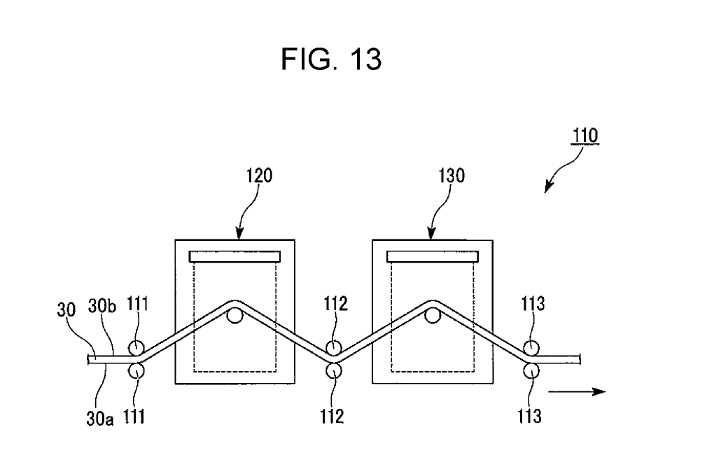

A sixth embodiment of the method for manufacturing the light-diffusing member will be described with reference to FIG. 13.

The method for manufacturing the light-diffusing member of the present embodiment is different from the method for manufacturing the light-diffusing member of the above-described first embodiment in that an exposure device 110 shown in FIG. 13 is used as the exposure device in the process of exposing the negative photosensitive resin layer 33. Other processes are the same as those in the method for manufacturing the light-diffusing member of the above-described first embodiment.

In FIG. 13, the same components as those shown in FIG. 2 will be assigned the same reference numerals, and the description thereof will be omitted. In FIG. 13, the light shielding layer 31 and the negative photosensitive resin layer 33 formed on the one surface 30a of the substrate 30 will be omitted.

In FIG. 13, a direction (direction shown by an arrow in FIG. 13) in which the substrate 30 is transferred is referred to as an X-axis direction, a width direction of the substrate 30 is referred to as a Y-axis direction, and a height direction of the exposure device 110 is referred to as a Z-axis direction.

The exposure device 110 schematically includes two exposure devices 120 and 130 (hereinafter, referred to as “a first exposure device 120 and a second exposure device 130”) arranged in the transfer direction of the substrate 30 with a prescribed distance, and first rollers 111 and 111, second rollers 112 and 112 and third rollers 113 and 113 which sequentially support the substrate 30 in the transfer direction.

For example, the same exposure device as that of any of the first embodiment to the fifth embodiment described above is used as the first exposure device 120 and the second exposure device 130. The first exposure device 120 and the second exposure device 130 may be the same device, or may be different devices. That is, in the first exposure device 120 and the second exposure device 130, the same exposure process may be performed, or different exposure processes may be performed.

The first rollers 111 and 111 are arranged on the one surface 30a and the other surface 30b of the substrate 30 and support (sandwich) the substrate 30 in the front stage of the first exposure device 120 on the supply side of the substrate 30.

The second rollers 112 and 112 are arranged on the one surface 30a and the other surface 30b of the substrate 30 between the first exposure device 120 and the second exposure device 130, and support (sandwich) the substrate 30.

The third rollers 113 and 113 are arranged on the one surface 30a and the other surface 30b of the substrate 30 in the rear stage of the second exposure device 130 and support (sandwich) the substrate 30, on the winding side of the substrate 30.

According to the present embodiment, since the first exposure device 120 and the second exposure device 130 are arranged in the transfer direction of the substrate 30, in each of the first exposure device 120 and the second exposure device 130, the parallel light F having a prescribed intensity can be incident on the negative photosensitive resin layer 33 formed on the one surface 30a of the substrate 30. Therefore, it is possible to form the light-diffusing section 34 having a prescribed taper angle. According to the present embodiment, it is possible to expose the negative photosensitive resin layer 33 by the parallel light F in two or more different directions.

According to the present embodiment, the light-diffusing member 35 on which the same light-diffusing section 34 as that of the above-described first embodiment is formed is obtained.

### (7) Seventh Embodiment

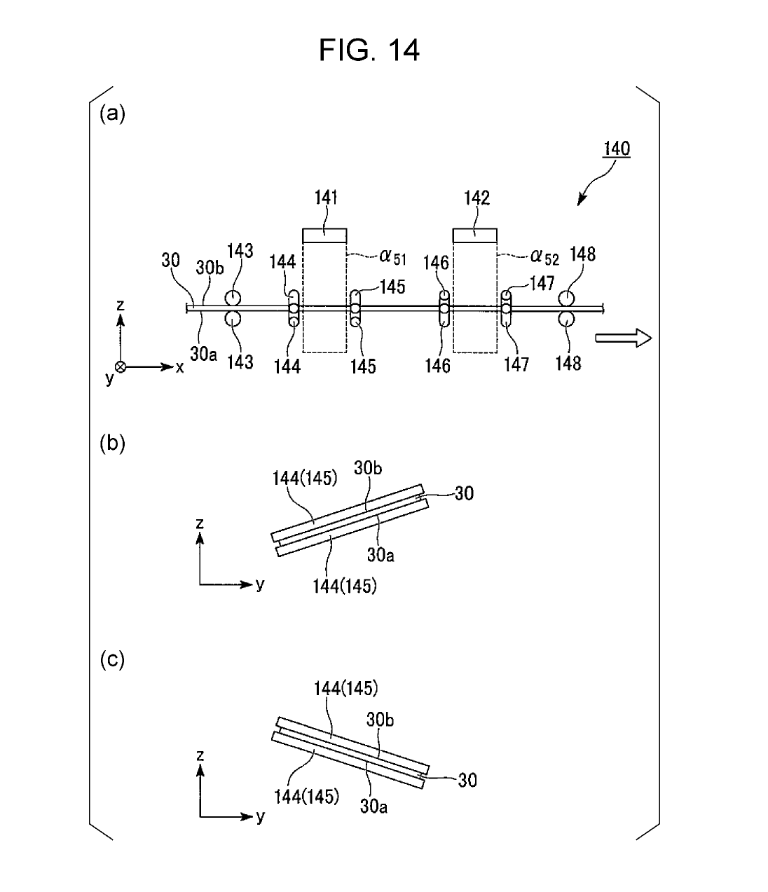

A seventh embodiment of the method for manufacturing the light-diffusing member will be described with reference to FIG. 14.

The method for manufacturing the light-diffusing member of the present embodiment is different from the method for manufacturing the light-diffusing member of the above-described first embodiment in that an exposure device 140 shown in FIG. 14 is used as the exposure device in the process of exposing the negative photosensitive resin layer 33. Other processes are the same as those in the method for manufacturing the light-diffusing member of the above-described first embodiment.

In FIG. 14, the same components as those shown in FIG. 2 will be assigned the same reference numerals, and the description thereof will be omitted. In FIG. 14, the light shielding layer 31 and the negative photosensitive resin layer 33 formed on the one surface 30a of the substrate 30 will be omitted.

In FIG. 14, a direction (direction shown by an arrow in FIG. 14) in which the substrate 30 is transferred is referred to as an X-axis direction, a width direction of the substrate 30 is referred to as a Y-axis direction, and a height direction of the exposure device 140 is referred to as a Z-axis direction.

The exposure device 140 schematically includes a first light source 141 and a second light source 142 for irradiating the negative photosensitive resin layer 33 formed on the one surface 30a of the substrate 30 with the parallel light such as ultraviolet light, and first rollers 143 and 143, second rollers 144 and 144, third rollers 145 and 145, fourth rollers 146 and 146, fifth rollers 147 and 147 and sixth rollers 148 and 148 which are arranged so as to correspond to two regions (exposure regions) α₅₁ and α₅₂ where the negative photosensitive resin layer 33 can be exposed by the first light source 141 and the second light source 142 and sequentially support the substrate 30 in the transfer direction.

The first light source 141 and the second light source 142 face the substrate 30, and are arranged so as to irradiate the substrate 30 in the transfer direction (X-axis direction) thereof with the parallel light F in a direction perpendicular to the transfer direction (X-axis direction) of the substrate 30. The first light source 141 is arranged between the second rollers 144 and 144 and the third rollers 145 and 145. The second light source 142 is arranged between the fourth rollers 146 and 146 and the fifth rollers 147 and 147.

For example, ultraviolet lamps are used as the first light source 141 and the second light source 142.

The first rollers 143 and 143 are arranged on the one surface 30a and the other surface 30b of the substrate 30 and support (sandwich) the substrate 30 on the supply side of the substrate 30.

The second rollers 144 and 144 are arranged in the transfer direction of the substrate 30 with a prescribed distance from the first rollers 143 and 143 and the third rollers 145 and 145, are arranged on the one surface 30a and the other surface 30b of the substrate 30, and support (sandwich) the substrate 30. The second rollers 144 and 144 are arranged near one end (end on the supply side of the substrate 30) of the exposure region α₅₁ on the supply side of the substrate 30. The second rollers 144 and 144 move at an arbitrary inclined angle with respect to the Y-axis direction while sandwiching the substrate 30 in line with the third rollers 145 and 145.

The third rollers 145 and 145 are arranged in the transfer direction of the substrate 30 with a prescribed distance from the second rollers 144 and 144 and the fourth rollers 146 and 146, are arranged on the one surface 30a and the other surface 30b of the substrate 30, and support (sandwich) the substrate 30. The third rollers 145 and 145 are arranged near the other end (end on the winding side of the substrate 30) of the exposure region α₅₁ on the supply side of the substrate 30. The third rollers 145 and 145 moves at an arbitrary inclined angle with respect to the Y-axis direction while sandwiching the substrate 30 in line with the second rollers 144 and 144.

The fourth rollers 146 and 146 are arranged in the transfer direction of the substrate 30 with a prescribed distance from the third rollers 145 and 145 and the fifth rollers 147 and 147, are arranged on the one surface 30a and the other surface 30b of the substrate 30, and support (sandwich) the substrate 30. The fourth rollers 146 and 146 are arranged near one end (end on the supply side of the substrate 30) of the exposure region α₅₂ on the winding side of the substrate 30. The fourth rollers 146 and 146 move at an arbitrary inclined angle with respect to the Y-axis direction while sandwiching the substrate 30 in line with the fifth rollers 147 and 147.

The fifth rollers 147 and 147 are arranged in the transfer direction of the substrate 30 with a prescribed distance from the fourth rollers 146 and 146 and the sixth rollers 148a and 148, are arranged on the one surface 30a and the other surface 30b of the substrate 30, and support (sandwich) the substrate 30. The fifth rollers 147 and 147 are arranged near the other end (end on the winding side of the substrate 30) of the exposure region α₅₂ on the winding side of the substrate 30. The fifth rollers 147 and 147 move at an arbitrary inclined angle with respect to the Y-axis direction while sandwiching the substrate 30 in line with the fourth rollers 146 and 146.

The sixth rollers 148 and 148 are arranged in the transfer direction of the substrate 30 with a prescribed distance from the fifth rollers 147 and 147, and are arranged on the one surface 30a and the other surface 30b of the substrate 30 and support (sandwich) the substrate 30 on the winding side of the substrate 30.

That is, the exposure region α₅₁ on the supply side of the substrate 30 is formed between the second rollers 144 and 144 and the third rollers 145 and 145, and the exposure region α₅₂ on the winding side of the substrate 30 is formed between the fourth rollers 146 and 146 and the fifth rollers 147 and 147.

For example, as shown in FIG. 14(b), in the process of exposing the negative photosensitive resin layer 33, the second rollers 144 and 144 and the third rollers 145 and 145 are inclined at an arbitrary inclined angle with respect to the Y-axis direction, that is, are inclined upward in the Z-axis direction with a Y axis as its reference, and thus, the substrate 30 is also inclined upward in the Z-axis direction with the Y axis as its reference. Accordingly, the substrate 30 can have an arbitrary inclined angle with respect to the normal direction, similarly to the method for manufacturing the light-diffusing member of the above-described first embodiment.

For example, as shown in FIG. 14(c), the fourth rollers 146 and 146 and the fifth rollers 147 and 147 are inclined at an arbitrary inclined angle with respect to the Y-axis direction, that is, are inclined downward in the Z-axis direction with the Y axis as its reference, and thus, the substrate 30 is also inclined downward in the Z-axis direction with the Y axis as its reference. Accordingly, the substrate 30 can have an arbitrary inclined angle with respect to the normal direction, similarly to the method for manufacturing the light-diffusing member of the above-described first embodiment.

Therefore, the parallel light F can be applied from the other surface 30b in a state in which the substrate 30 has the inclined angle with respect to the normal direction.

According to the present embodiment, the substrate 30 is inclined at an arbitrary inclined angle with respect to the Y-axis direction between the second rollers 144 and 144 and the third rollers 145 and 145, and the substrate 30 is inclined at an arbitrary inclined angle with respect to the Y-axis direction between the fourth rollers 146 and 146 and the fifth rollers 147 and 147. Thus, the parallel light F can be incident on the negative photosensitive resin layer 33 formed on the other surface 30a of the substrate 30 at a prescribed inclined angle. Therefore, it is possible to form the light-diffusing section 34 having a prescribed taper angle.

According to the present embodiment, an inclined direction of the substrate 30 between the second rollers 144 and 144 and the third rollers 145 and 145 and an inclined direction of the substrate 30 between the fourth rollers 146 and 146 and the fifth rollers 147 and 147 are different, and thus, it is possible to expose the negative photosensitive resin layer 33 by the parallel light F in two different directions.

According to the present embodiment, the light-diffusing member 35 on which the same light-diffusing section 34 as that of the above-described first embodiment is formed is obtained.

### (8) Eighth Embodiment

An eighth embodiment of the method for manufacturing the light-diffusing member will be described with reference to FIG. 15.

The method for manufacturing the light-diffusing member of the present embodiment is different from the method for manufacturing the light-diffusing member of the above-described first embodiment in that an exposure device 150 shown in FIG. 15 is used as the exposure device in the process of exposing the negative photosensitive resin layer 33. Other processes are the same as those in the method for manufacturing the light-diffusing member of the above-described first embodiment.

In FIG. 15, the same components as those shown in FIG. 2 will be assigned the same reference numerals, and the description thereof will be omitted. In FIG. 15, the light shielding layer 31 and the negative photosensitive resin layer 33 formed on the one surface 30a of the substrate 30 will be omitted.

In FIG. 15, a direction (direction shown by an arrow in FIG. 15) in which the substrate 30 is transferred is referred to as an X-axis direction, a width direction of the substrate 30 is referred to as a Y-axis direction, and a height direction of the exposure device 150 is referred to as a Z-axis direction.

The exposure device 150 schematically includes a light source 151 for irradiating the negative photosensitive resin layer 33 formed on the one surface 30a of the substrate 30 with the parallel light F such as ultraviolet light, and first rollers 152 and 152, a second roller 153, a third roller 154, and fourth rollers 155 and 155 which are arranged so as to correspond to a region (exposure region) α₆₁ where the negative photosensitive resin layer 33 can be exposed by the light source 151 and sequentially support the substrate 30 in the transfer direction.

The light source 151 faces the substrate 30, and is arranged so as to irradiate the substrate 30 in the transfer direction (X-axis direction) thereof with the parallel light F in a direction perpendicular to the transfer direction (X-axis direction) of the substrate 30.

For example, an ultraviolet lamp is used as the light source 151.

The first rollers 152 and 152 are arranged on the one surface 30a and the other surface 30b of the substrate 30 and support (sandwich) the substrate 30 on the supply side of the substrate 30. The first rollers 152 and 152 are arranged near one end (end on the supply side of the substrate 30) of the exposure region α₆₁.

The second roller 153 is arranged in the transfer direction of the substrate 30 with a prescribed distance from the first rollers 152 and 152 and the third roller 154, is arranged on the one surface 30a of the substrate 30 within the exposure region α₆₁, and supports the substrate 30. The second roller 153 moves in the Z-axis direction in line with the third roller 154, and is arranged higher than the first rollers 152 and 152 and the fourth rollers 155 and 155 in the Z-axis direction.

The third roller 154 is arranged in the transfer direction of the substrate 30 with a prescribed distance from the second roller 153 and the fourth rollers 155 and 155, is arranged on the one surface 30a of the substrate 30 within the exposure region α₆₁, and supports the substrate 30. The third roller 154 moves in the Z-axis direction in line with the second roller 153, and is arranged higher than the first rollers 152 and 152 and the fourth rollers 155 and 155 in the Z-axis direction.

The fourth rollers 155 and 155 are arranged in the transfer direction of the substrate 30 with a prescribed distance from the third roller 154 on the winding side of the substrate 30, are arranged on the one surface 30a and the other surface 30b of the substrate 30, and support (sandwich) the substrate 30. The fourth rollers 155 and 155 are arranged near the other end (end on the winding side of the substrate 30) of the exposure region α₆₁.

In the process of exposing the negative photosensitive resin layer 33, the positions of the second roller 153 and the third roller 154 move upward in the Z-axis direction (higher than the first rollers 152 and 152 and the fourth rollers 155 and 155 in the Z-axis direction), and thus, the substrate 30 can have an arbitrary inclined angle with respect to the X-axis direction between the first rollers 152 and 152 and the second roller 153 and between the third roller 154 and the fourth rollers 155 and 155, similarly to the method for manufacturing the light-diffusing member of the above-described first embodiment. Accordingly, the parallel light F can be applied from the other surface 30b while the substrate 30 has the inclined angle with respect to the normal direction between the first rollers 152 and 152 and the second roller 153 and between the third roller 154 and the fourth rollers 155 and 155.

In this case, the second roller 153 and the third roller 154 have the same positions (heights with an X axis as its reference). Thus, the substrate 30 passing (transferred) between the second roller 153 and the third roller 154 is in parallel with the X-axis direction. The substrate 30 can be irradiated with the parallel light F in a direction perpendicular to the transfer direction (X-axis direction) between the second roller 153 and the third roller 154.

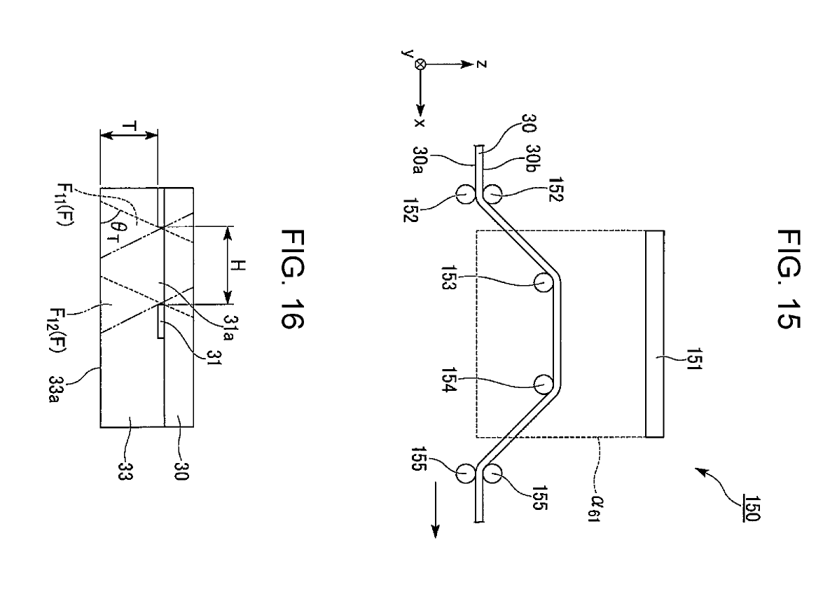

Here, as in the above-described first embodiment, an exposure state in a case where the substrate 30 on which the negative photosensitive resin layer 33 is formed is irradiated with the parallel light F in two different directions will be examined with reference to FIGS. 16 and 17.

In FIGS. 16 and 17, a width of an opening 31a of the light shielding layer 31 is expressed by H, a thickness of the negative photosensitive resin layer 33 is expressed by T, and an angle formed by the parallel light F applied to the negative photosensitive resin layer 33 and a surface (hereinafter, referred to as “one surface”) 33a opposite to the substrate 30 of the negative photosensitive resin layer 33 is expressed by θ_{T}.

As in the first embodiment, in a case where the substrate 30 on which the negative photosensitive resin layer 33 is formed is irradiated with the parallel light F in two different directions, and in a case where the width H, the thickness T and the angle θ_{T} satisfy the relationship of H≧2T/tan θ_{T} as shown in FIG. 16, since the parallel light rays F₁₁ and F₁₂ which pass through the opening 31a of the light shielding layer 31 and are incident on the negative photosensitive resin layer 33 overlap with each other on the one surface 33a of the negative photosensitive resin layer 33 in two different directions, there is no region which is not irradiated with the parallel light F. That is, there is no portion which is not exposed on the one surface 33a of the negative photosensitive resin layer 33.

In contrast, as in the first embodiment, in a case where the negative photosensitive resin layer 33 is irradiated with the parallel light F in two different directions, and in a case where the width H, the thickness T and the angle θ_{T} do not satisfy the relationship of H≧2T/tan θ_{T} as shown in FIG. 17, that is, in a case where the width H, the thickness T and the angle θ_{T} satisfy the relationship of H<2T/tan θ_{T}, since there is a region (region represented by γ in FIG. 17) where the parallel light rays F₁₁ and F₁₂ which pass through the opening 31a of the light shielding layer 31 and are incident on the negative photosensitive resin layer 33 in two different directions do not overlap with each other on the one surface 33a of the negative photosensitive resin layer 33, there is a region (region represented by γ in FIG. 17) which is not irradiated with the parallel light F. That is, there is a portion which is not exposed on the one surface 33a of the negative photosensitive resin layer 33.

This means that a region which is not irradiated with the parallel light F is generated by merely irradiating the negative photosensitive resin layer 33 with the parallel light F in two different directions in a case where the width H of the opening 31a is small or a case where the thickness of the negative photosensitive resin layer 33 is thick.

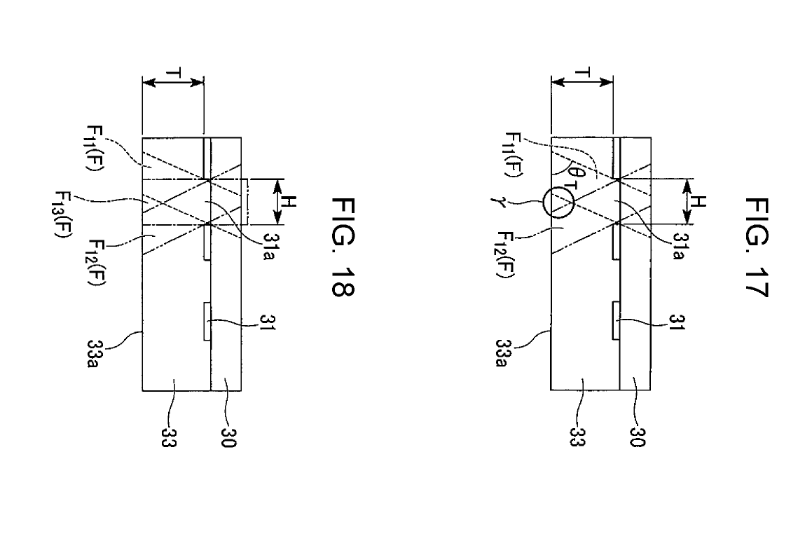

Thus, as in the present embodiment, the substrate 30 is arranged (transferred) in parallel with the X-axis direction between the second roller 153 and the third roller 154 within the exposure region α₆₁, and thus, the substrate 30 is irradiated with the parallel light F₁₃ in a direction perpendicular to the transfer direction (X-axis direction) in this portion, as shown in FIG. 18. Accordingly, even in a case where the width H, the thickness T and the angle θ_{T} satisfy the relationship of H<2T/tan θ_{T}, the substrate 30 is irradiated with the parallel light F₁₃ perpendicular to the transfer direction thereof in the a region of the negative photosensitive resin layer 33 which is not irradiated with the parallel light rays F₁₁ and F₁₂ incident in two different directions. Therefore, there is no region which is not exposed on the one surface 33a of the negative photosensitive resin layer 33. By doing this, even though the width H of the opening 31a of the light shielding layer 31 or the thickness T of the negative photosensitive resin layer 33 are changed, it is possible to prevent the portion which is not exposed on the one surface 33a of the negative photosensitive resin layer 33 from being present.

According to the present embodiment, the light-diffusing member 35 on which the same light-diffusing section 34 as that of the above-described first embodiment is formed is obtained.

### (9) Ninth Embodiment

A ninth embodiment of the method for manufacturing the light-diffusing member will be described with reference to FIG. 19.

The method for manufacturing the light-diffusing member of the present embodiment is different from the method for manufacturing the light-diffusing member of the above-described first embodiment in that an exposure device 160 shown in FIG. 19 is used as the exposure device in the process of exposing the negative photosensitive resin layer 33. Other processes are the same as those in the method for manufacturing the light-diffusing member of the above-described first embodiment.

In FIG. 19, the same components as those shown in FIG. 2 will be assigned the same reference numerals, and the description thereof will be omitted. In FIG. 19, the light shielding layer 31 and the negative photosensitive resin layer 33 formed on the one surface 30a of the substrate 30 will be omitted.

In FIG. 19, a direction (direction shown by an arrow in FIG. 19) in which the substrate 30 is transferred is referred to as an X-axis direction, a width direction of the substrate 30 is referred to as a Y-axis direction, and a height direction of the exposure device 160 is referred to as a Z-axis direction.

The exposure device 160 schematically includes three light sources 161, 162 and 163 for irradiating the negative photosensitive resin layer 33 formed on the one surface 30a of the substrate 30 with the parallel light F such as ultraviolet light, and first rollers 164 and 164, a second roller 165, a third roller 166, and fourth rollers 167 and 167 which are arranged so as to correspond to three regions (exposure regions) α₇₁, α₇₂, and α₇₃ (hereinafter, referred to as “a first exposure region α₇₁, a second exposure region α₇₂, and a third exposure region α₇₃”) where the negative photosensitive resin layer 33 can be exposed by the light sources 161, 162 and 163 and sequentially support the substrate 30 in the transfer direction.

The light sources 161, 162 and 163 face the substrate 30, and are arranged in the transfer direction (X-axis direction) of the substrate 30 with a prescribed distance. The light sources 161, 162 and 163 are arranged so as to irradiate the substrate 30 with the parallel light F in a direction perpendicular to the transfer direction (X-axis direction).

For example, ultraviolet lamps are used as the light sources 161, 162 and 163.

The first rollers 164 and 164 are arranged on the one surface 30a and the other surface 30b of the substrate 30 and support (sandwich) the substrate 30 on the supply side of the substrate 30. The first rollers 164 and 164 are arranged near one end (end on the supply side of the substrate 30) of the first exposure region α₇₁.

The second roller 165 is arranged in the transfer direction of the substrate 30 with a prescribed distance from the first rollers 164 and 164 and the third roller 166, is arranged on the one surface 30a of the substrate 30, and supports the substrate 30. The second roller 165 is arranged near the other end (end on the winding side of the substrate 30) of the first exposure region α₇₁ and near one end (end on the supply side of the substrate 30) of the second exposure region α₇₂. The second roller 165 moves in the Z-axis direction in line with the third roller 166, and is arranged higher than the first rollers 164 and 164 and the fourth rollers 167 and 167 in the Z-axis direction.

The third roller 166 is arranged in the transfer direction of the substrate 30 with a prescribed distance from the second roller 165 and the fourth rollers 167 and 167, is arranged on the one surface 30a of the substrate 30, and supports the substrate 30. The third roller 166 is arranged near the other end (end on the winding side of the substrate 30) of the second exposure region α₇₂ and near one end (end on the supply side of the substrate 30) of the third exposure region α₇₃. The third roller 166 moves in the Z-axis direction in line with the second roller 165, and is arranged higher than the first rollers 164 and 164 and the fourth rollers 167 and 167 in the Z-axis direction.

The fourth rollers 167 and 167 are arranged in the transfer direction of the substrate 30 with a prescribed distance from the third roller 166 on the winding side of the substrate 30, are arranged on the one surface 30a and the other surface 30b of the substrate 30, and support (sandwich) the substrate 30. The fourth rollers 167 and 167 are arranged near the other end (end on the winding side of the substrate 30) of the third exposure region α₇₃.

That is, the first exposure region α₇₁ is formed between the first rollers 164 and 164 and the second roller 165, the second exposure region α₇₂ is formed between the second roller 165 and third roller 166, and the third exposure region α₇₃ is formed between the third roller 166 and the fourth rollers 167 and 167.

In the process of exposing the negative photosensitive resin layer 33, the positions of the second roller 165 and the third roller 166 moves upward in the Z-axis direction (higher than first rollers 164 and 164 and the fourth rollers 167 and 167 in the Z-axis direction), and thus, the substrate 30 can have an arbitrary inclined angle with respect to the X-axis direction between the first rollers 164 and 164 and the second roller 165 and between the third roller 166 and the fourth rollers 167 and 167, similarly to the method for manufacturing the light-diffusing member of the above-described first embodiment. Accordingly, the parallel light F can be applied from the other surface 30b in a state in which the substrate 30 has the inclined angle with respect to the normal direction between the first rollers 164 and 164 and the second roller 165 and between the third roller 166 and the fourth rollers 167 and 167.

In this case, the second roller 165 and the third roller 166 have the same position (height with the X axis as its reference). Thus, the substrate 30 passing (transferred) between the second roller 165 and the third roller 166 is in parallel with the X-axis direction. The substrate 30 can be irradiated with the parallel light F in a direction perpendicular to the transfer direction (X-axis direction) thereof between the second roller 165 and the third roller 166.

According to the present embodiment, the substrate 30 is irradiated with the parallel light F at an arbitrary inclined angle with respect to the X-axis direction in the first exposure region α₇₁ formed between the first rollers 164 and 164 and the second roller 165, the substrate 30 is irradiated with the parallel light F in a direction perpendicular to the X-axis direction in the second exposure region α₇₂ formed between the second roller 165 and the third roller 166, and the substrate 30 is irradiated with the parallel light F at an arbitrary inclined angle with respect to the X-axis direction in the third exposure region α₇₃ formed between the third roller 166 and the fourth rollers 167 and 167. Thus, it is possible to prevent the portion which is not exposed on the one surface 33a of the negative photosensitive resin layer 33 formed on the substrate 30 from being present.

Since the first exposure region α₇₁ is formed between the first rollers 164 and 164 and the second roller 165, the second exposure region α₇₂ is formed between the second roller 165 and the third roller 166, and the third exposure region α₇₃ is formed between the third roller 166 and the fourth rollers 167 and 167, the parallel light having a prescribed intensity can be incident on the negative photosensitive resin layer 33 formed on the one surface 30a of the substrate 30 without shielding the parallel light emitted from the light sources 161, 162 and 163 by the first rollers 164 and 164, the second roller 165, the third roller 166 and the fourth rollers 167 and 167 provided in the exposure device 160. Therefore, it is possible to form the light-diffusing section 34 having a prescribed taper angle.

According to the present embodiment, the light-diffusing member 35 on which the same light-diffusing section 34 as that of the above-described first embodiment is formed is obtained.

### (10) Tenth Embodiment

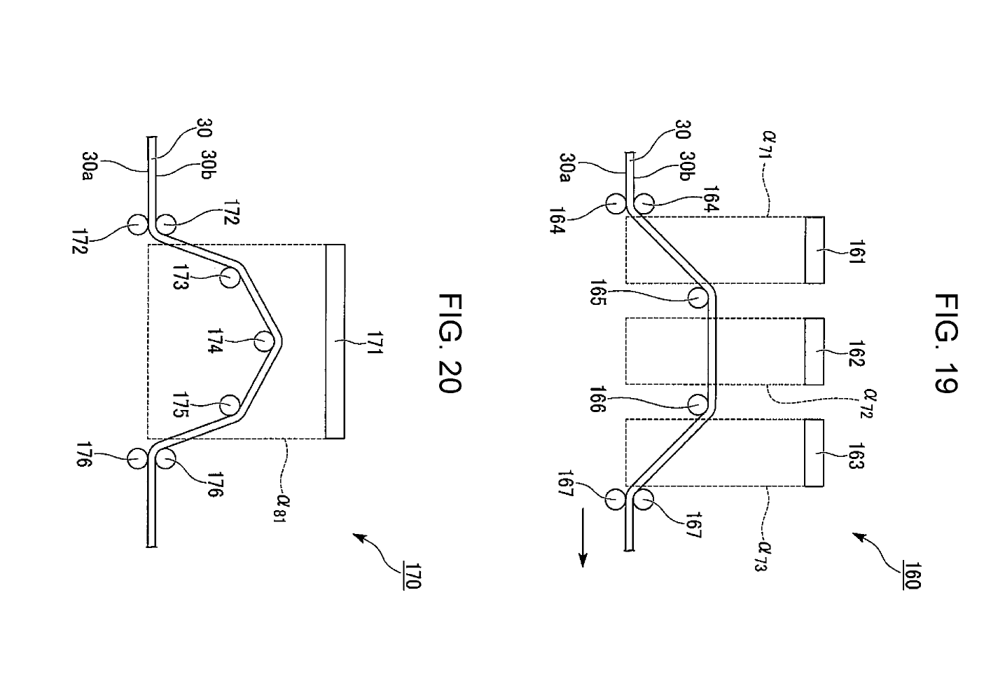

A tenth embodiment of the method for manufacturing the light-diffusing member will be described with reference to FIG. 20.

The method for manufacturing the light-diffusing member of the present embodiment is different from the method for manufacturing the light-diffusing member of the above-described first embodiment in that an exposure device 170 shown in FIG. 20 is used as the exposure device in the process of exposing the negative photosensitive resin layer 33. Other processes are the same as those in the method for manufacturing the light-diffusing member of the above-described first embodiment.

In FIG. 20, the same components as those shown in FIG. 2 will be assigned the same reference numerals, and the description thereof will be omitted. In FIG. 20, the light shielding layer 31 and the negative photosensitive resin layer 33 formed on the one surface 30a of the substrate 30 will be omitted.

In FIG. 20, a direction (direction shown by an arrow in FIG. 20) in which the substrate 30 is transferred is referred to as an X-axis direction, a width direction of the substrate 30 is referred to as a Y-axis direction, and a height direction of the exposure device 170 is referred to as a Z-axis direction.

The exposure device 170 schematically includes a light source 171 for irradiating the negative photosensitive resin layer 33 formed on the one surface 30a of the substrate 30 with the parallel light F such as ultraviolet light, and first rollers 172 and 172, a second roller 173, a third roller 174, a fourth roller 175 and fifth rollers 176 and 176 which are arranged so as to correspond to a region (exposure region) α₈₁ where the negative photosensitive resin layer 33 can be exposed by the light source 171 and sequentially support the substrate 30 in the transfer direction.

The light source 171 faces the substrate 30, and is arranged so as to irradiate the substrate 30 in the transfer direction (X-axis direction) thereof with the parallel light F in a direction perpendicular to the transfer direction (X-axis direction) of the substrate 30.

For example, an ultraviolet lamp is used as the light source 171.

The first rollers 172 and 172 are arranged on the one surface 30a and the other surface 30b of the substrate 30 and support (sandwich) the substrate 30 on the supply side of the substrate 30. The first rollers 172 and 172 are arranged near one end (end on the supply side of the substrate 30) of the exposure region α₈₁.

The second roller 173 is arranged in the transfer direction of the substrate 30 with a prescribed distance from the first rollers 172 and 172 and the third roller 174, is arranged on the one surface 30a of the substrate 30 within the exposure region α₈₁, and supports the substrate 30. The second roller 173 moves in the Z-axis direction in line with the third roller 174 and the fourth roller 175, and is arranged higher than the first rollers 172 and 172 and the fifth rollers 176 and 176 in the Z-axis direction and is arranged lower than the third roller 174 in the Z-axis direction.

The third roller 174 is arranged in the transfer direction of the substrate 30 with a prescribed distance from the second roller 173 and the fourth roller 175, is arranged on the one surface 30a of the substrate 30 in the center of the exposure region α₈₁, and supports the substrate 30. The third roller 174 moves in the Z-axis direction in line with the second roller 173 and the fourth roller 175, and is arranged higher than the first rollers 172 and 172, the second roller 173, the fourth roller 175 and the fifth rollers 176 and 176 in the Z-axis direction.

The fourth roller 175 is arranged in the transfer direction of the substrate 30 with a prescribed distance from the third roller 174 and the fifth rollers 176 and 176, is arranged on the one surface 30a of the substrate 30 within the exposure region α₈₁, and supports the substrate 30. The fourth roller 175 moves in the Z-axis direction in line with the second roller 173 and the third roller 174, and is arranged higher than the first rollers 172 and 172 and the fifth rollers 176 and 176 in the Z-axis direction and is arranged lower than the third roller 174 in the Z-axis direction.

The fifth rollers 176 and 176 are arranged in the transfer direction of the substrate 30 with a prescribed distance from the fourth roller 175 on the winding side of the substrate 30, are arranged on the one surface 30a and the other surface 30b of the substrate 30, and support (sandwich) the substrate 30. The fifth rollers 176 and 176 are arranged near the other end (end on the winding side of the substrate 30) of the exposure region α₈₁.

In the process of exposing the negative photosensitive resin layer 33, the positions of the second roller 173 and the fourth roller 175 move upward in the Z-axis direction (higher than the first rollers 172 and 172 and the fifth rollers 176 and 176 in the Z-axis direction and lower than the third roller 174 in the Z-axis direction), and the position of the third roller 174 moves upward in the Z-axis direction (higher than the first rollers 172 and 172, the second roller 173, the fourth roller 175, and the fifth rollers 176 and 176 in the Z-axis direction). Thus, the substrate 30 can have an arbitrary inclined angle with respect to the X-axis direction between the first rollers 172 and 172 and the second roller 173, between the second roller 173 and the third roller 174, between the third roller 174 and the fourth roller 175, and between the fourth roller 175 and the fifth rollers 176 and 176, similarly to the method for manufacturing the light-diffusing member of the above-described first embodiment. Accordingly, the parallel light F can be applied from the other surface 30b in a state in which the substrate 30 has the inclined angle with respect to the normal direction.

In this case, the second roller 173 and the fourth roller 175 have the same position (height with the X axis as its reference). By doing this, the incline with respect to the X-axis direction of the substrate 30 between the first rollers 172 and 172 and the second roller 173 and the incline with respect to the X-axis direction of the substrate 30 between the fourth roller 175 and the fifth rollers 176 and 176 can be equal to each other. The incline with respect to the X-axis direction of the substrate 30 between the second roller 173 and the third roller 174 and the incline with respect to the X-axis direction of the substrate 30 between the third roller 174 and the fourth roller 175 can be equal to each other. The incline with respect to the X-axis direction of the substrate 30 between the first rollers 172 and 172 and the second roller 173 and the incline with respect to the X-axis direction of the substrate 30 between the fourth roller 175 and the fifth rollers 176 and 176 (incline A), and the incline with respect to the X-axis direction of the substrate 30 between the second roller 173 and the third roller 174 and the incline with respect to the X-axis direction of the substrate 30 between the third roller 174 and the fourth roller 175 (incline B) can be different from each other. Specifically, for example, the incline A can be greater than the incline B, as shown in FIG. 20. Thus, the inclined angle of the parallel light F applied to the substrate 30 between the first rollers 172 and 172 and the second roller 173 and between the fourth roller 175 and the fifth rollers 176 and 176 and the inclined angle of the parallel light F applied to the substrate 30 between the second roller 173 and the third roller 174 and between the third roller 174 and the fourth roller 175 can be different from each other.

According to the present embodiment, the inclined angle of the parallel light F applied to the substrate 30 between first rollers 172 and 172 and the second roller 173 and between the fourth roller 175 and the fifth rollers 176 and 176 and the inclined angle of the parallel light F applied to the substrate 30 between the second roller 173 and the third roller 174 and between the third roller 174 and the fourth roller 175 are different from each other, and thus, it is possible to prevent the portion which is not exposed on the one surface 33a of the negative photosensitive resin layer 33 formed on the substrate 30 from being present.

According to the present embodiment, the light-diffusing member 35 on which the same light-diffusing section 34 as that of the above-described first embodiment is formed is obtained.

### (11) Eleventh Embodiment

An eleventh embodiment of the method for manufacturing the light-diffusing member will be described with reference to FIG. 21.

The method for manufacturing the light-diffusing member of the present embodiment is different from the method for manufacturing the light-diffusing member of the above-described first embodiment in that an exposure device 180 shown in FIG. 21 is used as the exposure device in the process of exposing the negative photosensitive resin layer 33. Other processes are the same as those in the method for manufacturing the light-diffusing member of the above-described first embodiment.

In FIG. 21, the same components as those shown in FIG. 2 will be assigned the same reference numerals, and the description thereof will be omitted. In FIG. 21, the light shielding layer 31 and the negative photosensitive resin layer 33 formed on the one surface 30a of the substrate 30 will be omitted.

In FIG. 21, a direction (direction shown by an arrow in FIG. 21) in which the substrate 30 is transferred is referred to as an X-axis direction, a width direction of the substrate 30 is referred to as a Y-axis direction, and a height direction of the exposure device 180 is referred to as a Z-axis direction.

The exposure device 180 schematically includes a light source 181 for irradiating the negative photosensitive resin layer 33 formed on the one surface 30a of the substrate 30 with the parallel light F such as ultraviolet light, and first rollers 182 and 182, a second roller 183, and third rollers 184 and 184 which are arranged so as to correspond to a region (exposure region) α₉₁ where the negative photosensitive resin layer 33 can be exposed by the light source 181 and sequentially support the substrate 30 in the transfer direction.

The light source 181 faces the substrate 30, and is arranged so as to irradiate the substrate 30 with the parallel light F in a direction perpendicular to the transfer direction (X-axis direction) thereof.

For example, an ultraviolet lamp is used as the light source 181.

The first rollers 182 and 182 are arranged on the one surface 30a and the other surface 30b of the substrate 30 and support (sandwich) the substrate 30 on the supply side of the substrate 30. The first rollers 182 and 182 are arranged near one end (end on the supply side of the substrate 30) of the exposure region α₉₁.

The second roller 183 is arranged in the transfer direction of the substrate 30 with a prescribed distance from the first rollers 182 and 182 and the third rollers 184 and 184, is arranged on the one surface 30a of the substrate 30 within the exposure region α₉₁, and supports the substrate 30. The second roller 183 is arranged closer to the winding side of the substrate 30 than the center of the exposure region α₉₁ within the exposure region α₉₁. The second roller 183 moves in the X-axis direction, and is arranged higher than the first rollers 182 and 182 and the third rollers 184 and 184 in the Z-axis direction.

The third rollers 184 and 184 are arranged in the transfer direction of the substrate 30 with a prescribed distance from the second roller 183 on the winding side of the substrate 30, are arranged on the one surface 30a and the other surface 30b of the substrate 30, and support (sandwich) the substrate 30. The third rollers 184 and 184 are arranged near the other end (end on the winding side of the substrate 30) of the exposure region α₉₁.

In the process of exposing the negative photosensitive resin layer 33, the position of the second roller 183 moves upward in the Z-axis direction (higher than the first rollers 182 and 182 and the third rollers 184 and 184 in the Z-axis direction), and thus, the substrate 30 can have an arbitrary inclined angle with respect to the X-axis direction. Thus, the parallel light F can be applied from the other surface 30b in a state in which the substrate 30 has the inclined angle with respect to the normal direction.

In this case, since the second roller 183 is arranged closer to the winding side of the substrate 30 than the center of the exposure region α₉₁ within the exposure region α₉₁, the incline with respect to the X-axis direction of the substrate 30 between the first rollers 182 and 182 and the second roller 183 and the incline with respect to the substrate 30 between the second roller 183 and the third rollers 184 and 184 are different from each other, as shown in FIG. 21. Accordingly, the inclined angle of the parallel light F applied to the substrate 30 between the first rollers 182 and 182 and the second roller 183 and the inclined angle of the parallel light F applied to the substrate 30 between the second roller 183 and the third rollers 184 and 184 can be different from each other. That is, the inclined angle of the parallel light F with respect to the normal direction of the substrate 30 between the first rollers 182 and 182 and the second roller 183 and the inclined angle of the parallel light F with respect to the normal direction of the substrate 30 between the second roller 183 and the third rollers 184 and 184 can be different from each other.

According to the present embodiment, the inclined angle of the parallel light F applied to the substrate 30 between the first rollers 182 and 182 and the second roller 183 and the inclined angle of the parallel light F applied to the substrate 30 between the second roller 183 and the third rollers 184 and 184 are different from each other, and thus, the parallel light F can be incident on the substrate 30 so as to be asymmetrical with respect to the normal direction thereof with the second roller 183 as its boundary. Accordingly, it is possible to expose the negative photosensitive resin layer 33 formed on the substrate 30 so as to be bilaterally asymmetrical with respect to the normal direction of the substrate 30.

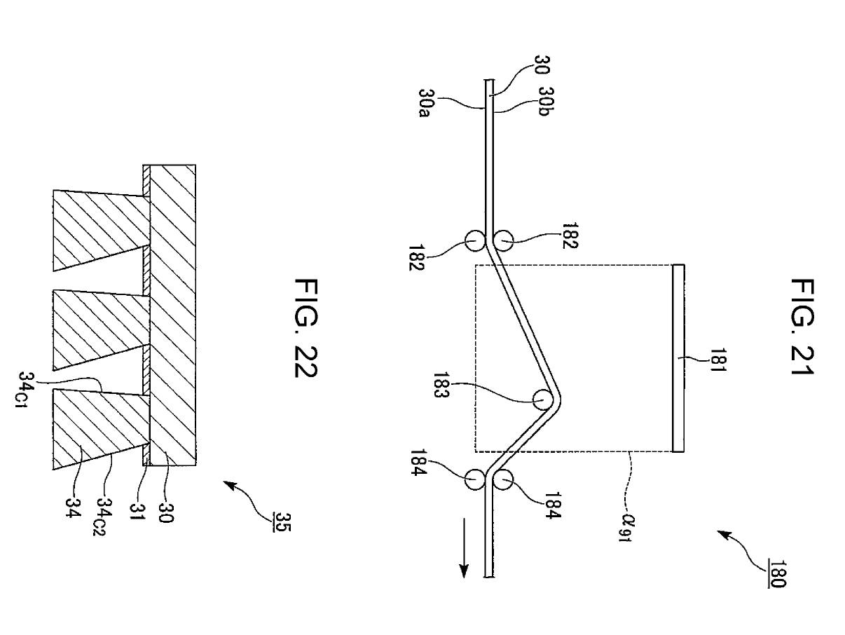

That is, according to the present embodiment, the light-diffusing member 35 on which the light-diffusing section 34 in which angles (taper angles) of taper-shaped side surface 34c1 and 34c2 are bilaterally asymmetrical on the section of the substrate 30 in the normal direction is obtained, as shown in FIG. 22.

### (12) Twelfth Embodiment

A twelfth embodiment of the method for manufacturing the light-diffusing member will be described with reference to FIG. 23.

The method for manufacturing the light-diffusing member of the present embodiment is different from the method for manufacturing the light-diffusing member of the above-described first embodiment in that an exposure device 190 shown in FIG. 23 is used as the exposure device in the process of exposing the negative photosensitive resin layer 33. Other processes are the same as those in the method for manufacturing the light-diffusing member of the above-described first embodiment.

In FIG. 23, the same components as those shown in FIG. 2 will be assigned the same reference numerals, and the description thereof will be omitted. In FIG. 23, the light shielding layer 31 and the negative photosensitive resin layer 33 formed on the one surface 30a of the substrate 30 will be omitted.

In FIG. 23, a direction (direction shown by an arrow in FIG. 23) in which the substrate 30 is transferred is referred to as an X-axis direction, a width direction of the substrate 30 is referred to as a Y-axis direction, and a height direction of the exposure device 190 is referred to as a Z-axis direction.

The exposure device 190 schematically includes a light source 191 for irradiating the negative photosensitive resin layer 33 formed on the one surface 30a of the substrate 30, and first rollers 192 and 192, a second roller 193, and a third roller 194 which are arranged so as to correspond to a region (exposure region) α₁₀₁ where the negative photosensitive resin layer 33 can be exposed by the light source 191 and sequentially support the substrate 30 in the transfer direction.

The light source 191 faces the substrate 30, and is arranged so as to irradiate the substrate 30 with the parallel light F in a direction perpendicular to the transfer direction (X-axis direction).

For example, an ultraviolet lamp is used as the light source 191.

The first rollers 192 and 192 are arranged on the one surface 30a and the other surface 30b of the substrate 30 and support (sandwich) the substrate 30 on the supply side of the substrate 30. The first rollers 192 and 982 are arranged near one end (end on the supply side of the substrate 30) of the exposure region α₁₀₁.

The second roller 193 is arranged in the transfer direction of the substrate 30 with a prescribed distance from the first rollers 192 and 192 and the third roller 194, is arranged on the one surface 30a of the substrate 30 within the exposure region α₁₀₁, and supports the substrate 30.

The second roller 193 is arranged closer to the winding side of the substrate 30 than the center of the exposure region α₁₀₁ within the exposure region α₁₀₁. The second roller 193 moves in the Z-axis direction in line with the third roller 194, and is arranged higher than the first rollers 192 and 192 in the Z-axis direction.

The third roller 194 is arranged in the transfer direction of the substrate 30 with a prescribed distance from the second roller 193 on the winding side of the substrate 30, is arranged on the one surface 30a of the substrate 30, and supports the substrate 30. The third roller 194 moves in the Z-axis direction in line with the second roller 193, and is arranged higher than the first rollers 192 and 192 in the Z-axis direction.

In the process of exposing the negative photosensitive resin layer 33, the positions of the second roller 193 and the third roller 194 moves upward in the Z-axis direction (higher than the first rollers 192 and 192 in the Z-axis direction), and the second roller 193 and the third roller 194 have the same the positions (height with the X axis as its reference). Thus, the substrate 30 can have an arbitrary inclined angle with respect to the X-axis direction between the first rollers 192 and 192 and the second roller 193. Accordingly, the parallel light F can be applied from the other surface 30b in a state in which the substrate 30 has the inclined angle with respect to the normal direction.

The substrate 30 is transferred in parallel with the X-axis direction between the second roller 193 and the third roller 194. The substrate 30 can be irradiated with the parallel light F from the other surface 30b in a direction perpendicular to the transfer direction (X-axis direction) thereof between the second roller 193 and the third roller 194.

According to the present embodiment, the substrate 30 has the inclined angle with respect to the normal direction (is inclined) between the first rollers 192 and 192 and the second roller 193, and the parallel light F is applied. Thus, the substrate 30 can be irradiated with the parallel light F in parallel with the normal direction between the second roller 193 and the third roller 194. Accordingly, it is possible to expose the negative photosensitive resin layer 33 formed on the substrate 30 so as to be bilaterally asymmetrical with respect to the normal direction of the substrate 30. It is possible to adjust the inclined angle with respect to the X-axis direction of the substrate 30 between the first rollers 192 and 192 and the second roller 193 by the positions of the second roller 193 and the third roller 194.

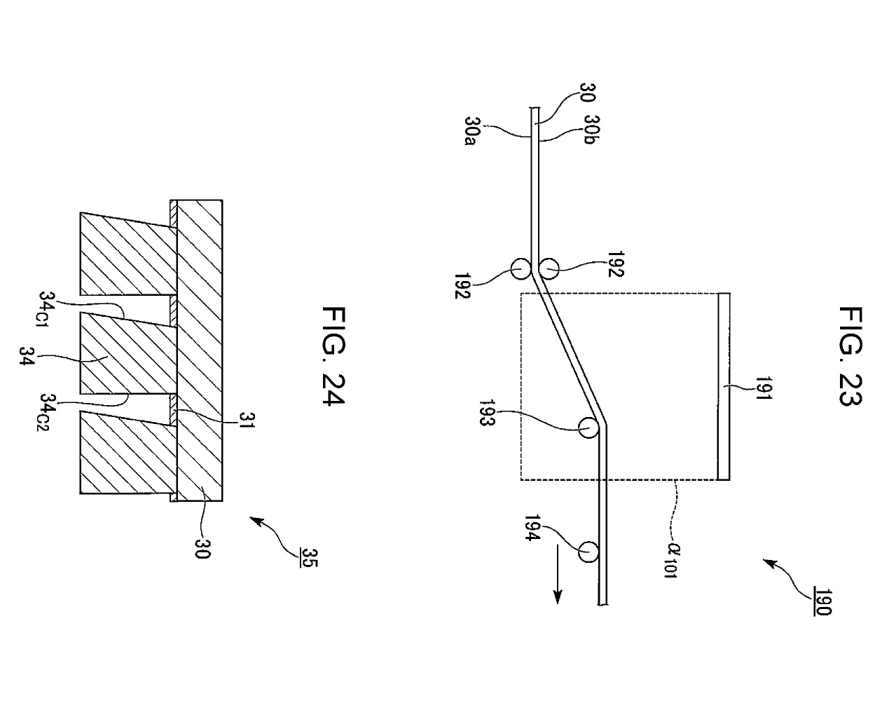

That is, according to the present embodiment, the light-diffusing member 35 on which the light-diffusing section 34 in which angles (taper angles) of taper-shaped side surfaces 34c1 and 34c2 are laterally asymmetrical is formed on the section of the substrate 30 in the normal direction is obtained, as shown in FIG. 24. Specifically, the side surface 34c1 of the light-diffusing section 34 has an inclined angle with respect to the normal direction of the substrate 30, and the side surface 34c2 of the light-diffusing section 34 is parallel with the normal direction of the substrate 30.

### (13) Thirteenth Embodiment

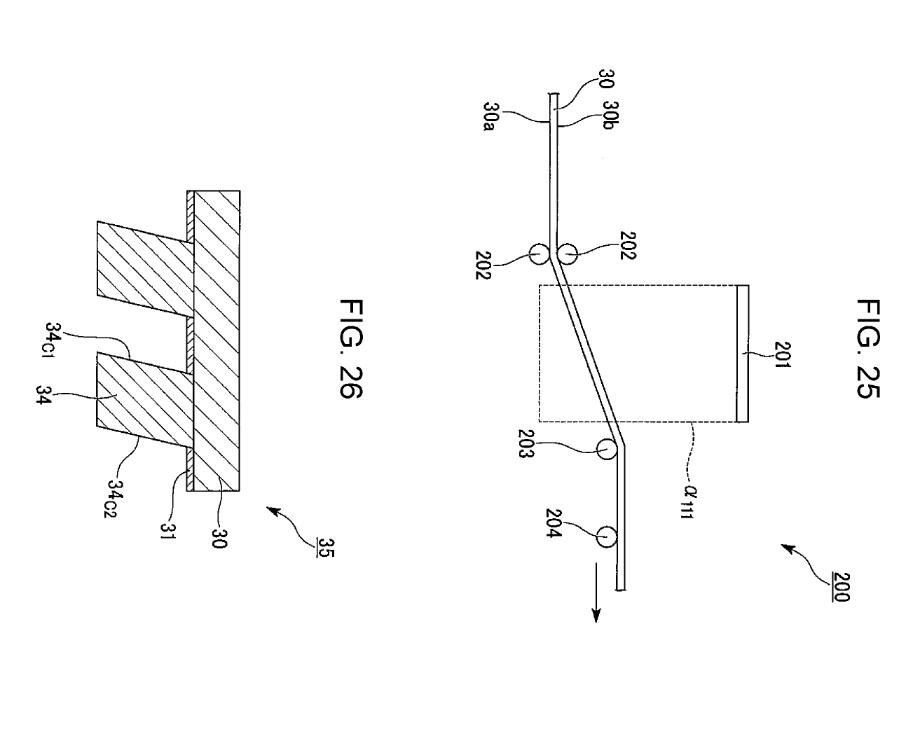

A thirteenth embodiment of the method for manufacturing the light-diffusing member will be described with reference to FIG. 25.

The method for manufacturing the light-diffusing member of the present embodiment is different from the method for manufacturing the light-diffusing member of the above-described first embodiment in that an exposure device 200 shown in FIG. 25 is used as the exposure device in the process of exposing the negative photosensitive resin layer 33. Other processes are the same as those in the method for manufacturing the light-diffusing member of the above-described first embodiment.

In FIG. 25, the same components as those shown in FIG. 2 will be assigned the same reference numerals, and the description thereof will be omitted. In FIG. 25, the light shielding layer 31 and the negative photosensitive resin layer 33 formed on the one surface 30a of the substrate 30 will be omitted.

In FIG. 25, a direction (direction shown by an arrow in FIG. 25) in which the substrate 30 is transferred is referred to as an X-axis direction, a width direction of the substrate 30 is referred to as a Y-axis direction, and a height direction of the exposure device 200 is referred to as a Z-axis direction.

The exposure device 200 schematically includes a light source 201 for irradiating the negative photosensitive resin layer 33 formed on the one surface 30a of the substrate 30 with the parallel light F such as ultraviolet light, and first rollers 202 and 202, a second roller 203, and a third roller 204 which are arranged so as to correspond to a region (exposure region) α₁₁₁ where the negative photosensitive resin layer 33 can be exposed by the light source 201 and sequentially support the substrate 30 in the transfer direction.

The light source 201 faces the substrate 30, and is arranged so as to irradiate the substrate 30 with the parallel light F in a direction perpendicular to the transfer direction (X-axis direction).

For example, an ultraviolet lamp is used as the light source 201.

The first rollers 202 and 202 are arranged on the one surface 30a and the other surface 30b of the substrate 30 and support (sandwich) the substrate 30 on the supply side of the substrate 30. The first rollers 202 and 202 are arranged near one end (end on the supply side of the substrate 30) of the exposure region α₁₁₁.

The second roller 203 is arranged in the transfer direction of the substrate 30 with a prescribed distance from the first rollers 202 and 202 and the third roller 204, is arranged on the one surface 30a of the substrate 30, and supports the substrate 30. The second roller 203 is arranged near the other end (end on the winding side of the substrate 30) of the exposure region α₁₁₁. The second roller 203 moves in the Z-axis direction in line with the third roller 204, and is arranged higher than the first rollers 202 and 202 in the Z-axis direction.

The third roller 204 is arranged in the transfer direction of the substrate 30 with a prescribed distance from the second roller 203 on the winding side of the substrate 30, and is arranged on the one surface 30a of the substrate 30 and supports the substrate 30. The third roller 204 moves in the Z-axis direction in line with the second roller 203, and is arranged higher than the first rollers 202 and 202 in the Z-axis direction.

That is, the exposure region α₁₁₁ is formed between the first rollers 202 and 202 and the second roller 203.

In the process of exposing the negative photosensitive resin layer 33, the positions of the second roller 203 and the third roller 204 move upward in the Z-axis direction (higher than the first rollers 202 and 202 in the Z-axis direction), and the second roller 203 and the third roller 204 have the same position (height with the X axis as its reference). Thus, the substrate 30 can have an arbitrary inclined angle with respect to the X-axis direction between the first rollers 202 and 202 and the second roller 203. Accordingly, it is possible to apply the parallel light F from the other surface 30b in a state in which the normal direction of the substrate 30 has the inclined angle with respect to the normal direction.

According to the present embodiment, the substrate 30 has the inclined angle with respect to the normal direction (is inclined) between the first rollers 202 and 202 and the second roller 203, and the parallel light F can be applied. Thus, the negative photosensitive resin layer 33 formed on the substrate 30 can be exposed by being inclined in one direction with respect to the normal direction of the substrate 30. It is possible to adjust the inclined angle with respect to the X-axis direction of the substrate 30 between the first rollers 202 and 202 and the second roller 203 by the positions of the second roller 203 and the third roller 204.

That is, according to the present embodiment, the light-diffusing member 35 on which the light-diffusing section 34 in which angles (taper angles) of taper-shaped side surfaces 34c1 and 34c2 are equal is formed is obtained on the section of the substrate 30 in the normal direction, as shown in FIG. 26. Specifically, the side surface 34c1 of the light-diffusing section 34 and the side surface 34c2 of the light-diffusing section 34 are in parallel with each other.

### (14) Fourteenth Embodiment

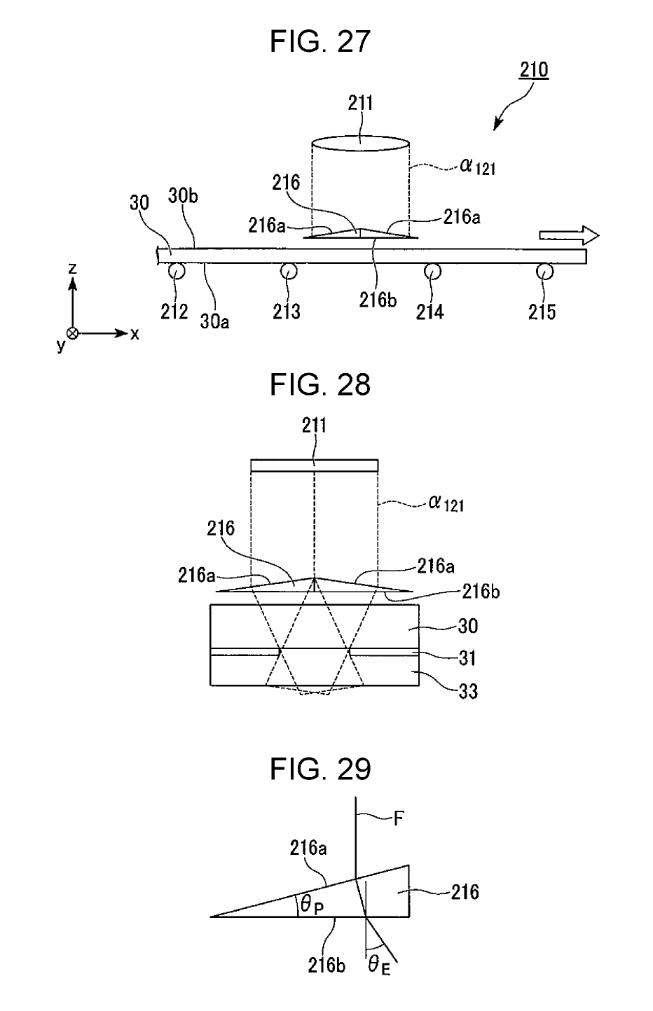

A fourteenth embodiment of the method for manufacturing the light-diffusing member will be described with reference to FIG. 27.

The method for manufacturing the light-diffusing member of the present embodiment is different from the method for manufacturing the light-diffusing member of the above-described first embodiment in that an exposure device 210 shown in FIG. 27 is used as the exposure device in the process of exposing the negative photosensitive resin layer 33. Other processes are the same as those in the method for manufacturing the light-diffusing member of the above-described first embodiment.

In FIG. 27, the same components as those shown in FIG. 2 will be assigned the same reference numerals, and the description thereof will be omitted. In FIG. 27, the light shielding layer 31 and the negative photosensitive resin layer 33 formed on the one surface 30a of the substrate 30 will be omitted.

In FIG. 27, a direction (direction shown by an arrow in FIG. 27) in which the substrate 30 is transferred is referred to as an X-axis direction, a width direction of the substrate 30 is referred to as a Y-axis direction, and a height direction of the exposure device 210 is referred to as a Z-axis direction.

The exposure device 210 schematically includes a light source 211 for irradiating the negative photosensitive resin layer 33 formed on the one surface 30a of the substrate 30 with the parallel light F such as ultraviolet light, a first roller 212, a second roller 213, a third roller 214, and a fourth roller 215 which sequentially support the substrate 30 in the transfer direction, and a prism 216 disposed between the substrate 30 transferred by the rollers and the light source 211.

The light source 211 faces the substrate 30, and is arranged so as to irradiate the substrate 30 with the parallel light F in a direction perpendicular to the transfer direction (X-axis direction).

For example, an ultraviolet lamp is used as the light source 211.

The first roller 212 is arranged on the one surface 30a of the substrate 30 and supports the substrate 30 on the supply side of the substrate 30.

The second roller 213 is arranged in the transfer direction of the substrate 30 with a prescribed distance from the first roller 212 and the third roller 214, is arranged on the one surface 30a of the substrate 30, and supports the substrate 30. The second roller 213 is arranged near one end (end on the supply side of the substrate 30) of a region (exposure region) α₁₂₁ where the negative photosensitive rein layer 33 can be exposed by the light source 211.

The third roller 214 is arranged in the transfer direction of the substrate 30 with a prescribed distance from the second roller 213 and the fourth roller 215, is arranged on the one surface 30a of the substrate 30, and supports the substrate 30. The third roller 214 is arranged near the other end (end on the winding side of the substrate 30) of the exposure region α₁₂₁ of the substrate 30.

The fourth roller 215 is arranged in the transfer direction of the substrate 30 with a prescribed distance from the third roller 214, and is arranged on the one surface 30a of the substrate 30 and supports the substrate 30 on the winding side of the substrate 30.

The exposure region α₁₂₁ is formed between the second roller 213 and the third roller 214.

The prism 216 has a shape in which the section parallel to the height direction has an isosceles triangle shape. The prism 216 is arranged between the light source 211 and the substrate 30 such that a direction in which an inclined surface 216a is present, that is, a longitudinal direction of a base 216b is in parallel with the transfer direction (X-axis direction) of the substrate 30. The prism 216 allows the parallel light F emitted from the light source 211 from the inclined surface 216a having an isosceles triangle shape to be incident, refracts the parallel light F, and emits the base surface 216b having an isosceles triangle shape.

In the process of exposing the negative photosensitive resin layer 33, if the parallel light F emitted from the light source 211 is incident from the inclined surface 216a of the prism 216, the parallel light is refracted, is inclined toward a central line passing through an apex angle of the prism 216, is emitted from the bottom surface 216b, and is incident on the substrate 30 at an inclined angle (so as to be inclined) with respect to the normal direction. More specifically, in FIG. 28, in the prism 216, in a left portion of the central line passing through the apex angle, the parallel light F refracted from the prism 216 is emitted from the bottom surface 216b of the prism 216 so as to be inclined toward the central line (right side) passing through the apex angle of the prism 216. Meanwhile, in FIG. 28, in the prism 216, in a right portion of the central line passing through the apex angle, the parallel light F refracted from the prism 216 is emitted from the bottom surface 216b of the prism 216 so as to be inclined toward the central line (left side) passing through the apex angle of the prism 216. In a case where the inclined angle of the prism 216, that is, an inclined angle θₚ of the inclined surface 216a with respect to the bottom surface 216b of the prism 216 is equal in the left and right portions with the central line passing through the apex angle of the prism 216 as its boundary, an inclined angle θ_{E} of the parallel light F emitted from the bottom surface 216b of the prism 216 is also equal in the left and right portions with the central line passing through the apex angle of the prism 216 as its boundary (see FIG. 29).

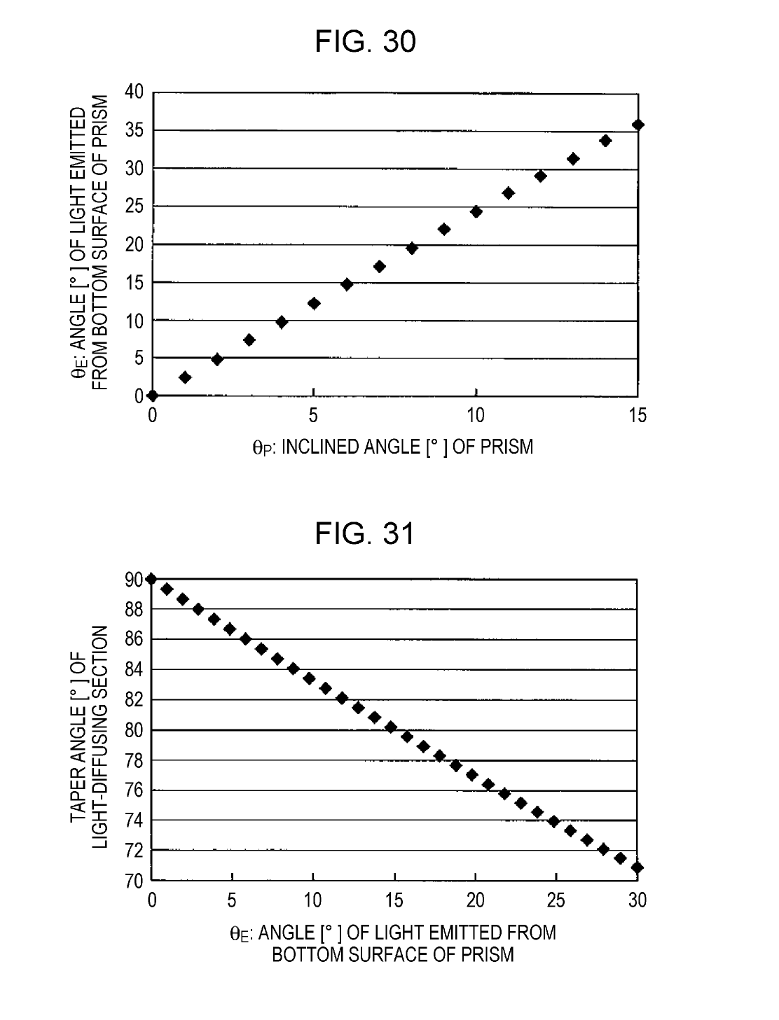

For example, it is assumed that a refractive index of ultraviolet light (wavelength: 365 nm) of the prism 216 is n=1.5. If the inclined angle θₚ of the prism 216 is 6 degrees, the parallel light F of which the inclined angle θ_{E} is 15 degrees is emitted from the bottom surface 216b of the prism 216. By using the prism 216, the parallel light F inclined at 15 degrees with respect to the normal direction of the substrate 30 is incident, and is refracted from the inside of the substrate 30. For this reason, in the negative photosensitive resin layer 33 and the substrate 30, since the parallel light is inclined at 10 degrees with respect to the normal direction of the substrate 30, it is possible to set the taper angle of the light-diffusing section 34 to be 80 degrees. As shown in FIG. 30, the inclined angle θₚ of the prism 216 and the inclined angle θ_{E} of the light emitted from the bottom surface 216b of the prism 216 are proportional to each other. As shown in FIG. 31, the inclined angle θ_{E} of the light emitted from the bottom surface 216b of the prism 216 and the taper angle of the light-diffusing section 34 are inversely proportional to each other.

According to the present embodiment, the parallel light F emitted from the light source 211 is refracted using the prism 216, and thus, the parallel light F can be incident on the substrate 30 at the inclined angle with respect to the normal direction thereof. According to the present embodiment, it is possible to expose the negative photosensitive resin layer 33 by the parallel light F in different two directions.

According to the present embodiment, the light-diffusing member 35 on which the same light-diffusing section 34 as that of the above-described first embodiment is formed is obtained.

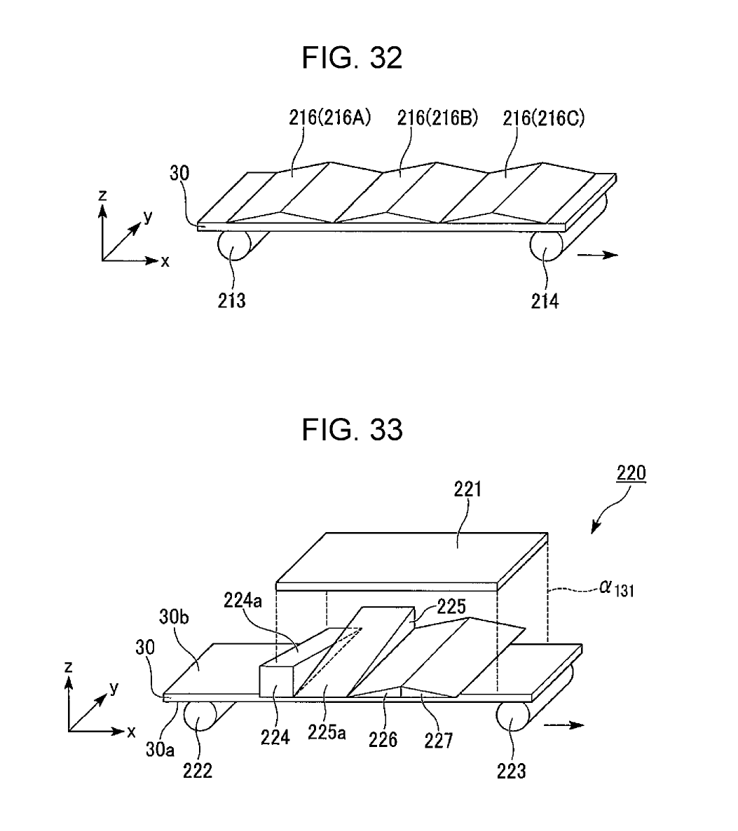

Although it has been described in the present embodiment that one prism 216 is arranged between the second roller 213 and the third roller 214, the present embodiment is not limited thereto. In the present embodiment, two prisms 216 may be arranged between the second roller 213 and the third roller 214, three prisms 216 (216A, 216B and 216C) may be arranged between the second roller 213 and the third roller 214 as shown in FIG. 32, or four or more prisms 216 may be arranged between the second roller 213 and the third roller 214.

### (15) Fifteenth Embodiment

A fifteenth embodiment of the method for manufacturing the light-diffusing member will be described with reference to FIGS. 33 to 35.

The method for manufacturing the light-diffusing member of the present embodiment is different from the method for manufacturing the light-diffusing member of the above-described first embodiment in that an exposure device 220 shown in FIG. 33 is used as the exposure device in the process of exposing the negative photosensitive resin layer 33. Other processes are the same as those in the method for manufacturing the light-diffusing member of the above-described first embodiment.

In FIG. 33, the same components as those shown in FIG. 2 will be assigned the same reference numerals, and the description thereof will be omitted. In FIG. 33, the light shielding layer 31 and the negative photosensitive resin layer 33 formed on the one surface 30a of the substrate 30 will be omitted.

In FIG. 33, a direction (direction shown by an arrow in FIG. 33) in which the substrate 30 is transferred is referred to as an X-axis direction, a width direction of the substrate 30 is referred to as a Y-axis direction, and a height direction of the exposure device 220 is referred to as a Z-axis direction.

The exposure device 220 schematically includes a light source 221 for irradiating the negative photosensitive resin layer 33 formed on the one surface 30a of the substrate 30 with the parallel light F such as the ultraviolet light, a first roller 222 and a second roller 223 which sequentially support the substrate 30 in the transfer direction, and a first prism 224, a second prism 225, a third prism 226 and a fourth prism 227 which are sequentially arranged so as to be in continuously contact with the substrate 30 in the transfer direction between the substrate 30 transferred by the rollers and the light source.

The light source 221 faces the substrate 30, and is arranged so as to irradiate the substrate 30 with the parallel light F in a direction perpendicular to the transfer direction (X-axis direction).

For example, an ultraviolet lamp is used as the light source 221.

The first roller 222 is arranged on the one surface 30a of the substrate 30 and supports the substrate 30 on the supply side of the substrate 30. The first roller 222 is arranged near one end (end on the supply side of the substrate 30) of a region (exposure region) α₁₃₁ where the negative photosensitive resin layer 33 can be exposed by the light source 221.

The second roller 223 is arranged in the transfer direction of the substrate 30 with a prescribed distance from the first roller 222, and is arranged on the one surface 30a of the substrate 30 and supports the substrate 30 on the winding side of the substrate 30. The second roller 223 is arranged near the other end (end on the winding side of the substrate 30) of the exposure region α₁₃₁ of the substrate 30.

That is, the exposure region α₁₃₁ is formed between the first roller 222 and the second roller 223.

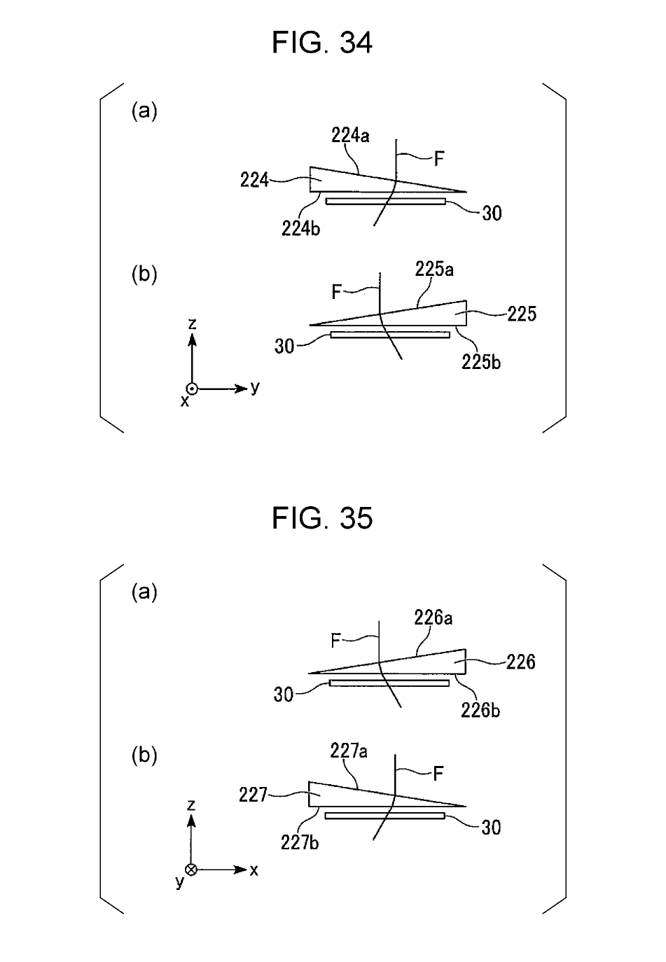

The first prism 224 has a shape in which the section parallel to the Z-axis direction is a right triangle while being arranged on the substrate 30. The first prism 224 is arranged on the substrate 30 such that an inclined surface 224a is positioned on an upper side in the Z-axis direction and a longitudinal direction of a bottom surface (surface facing the inclined surface 224a) 224b is in parallel with the Y-axis direction. The first prism 224 is arranged in a direction in which the inclined surface 224a having a right triangle becomes lower toward the deep side of the paper surface. As shown in FIG. 34, the first prism 224 allows the parallel light F emitted from the light source 221 to be incident from the inclined surface 224a having a right triangle, refracts the parallel light F, and emits the parallel light from the bottom surface 224b having a right triangle.

The second prism 225 has a shape in which the section parallel to the Z-axis direction is a right triangle while being arranged on the substrate 30. The second prism 225 is arranged on the substrate 30 such that an inclined surface 225a is positioned on an upper side in the Z-axis direction and a longitudinal direction of a bottom surface (surface facing the inclined surface 225a) 225b is in parallel with the Y-axis direction. The second prism 225 is arranged in a direction in which the inclined surface 225a having a right triangle becomes lower toward the front side of the paper surface. As shown in FIG. 34, the second prism 225 allows the parallel light F emitted from the light source 221 to be incident from the inclined surface 225a having a right triangle, refracts the parallel light F, and emits the parallel light from the bottom surface 225b having a right triangle.

The third prism 226 has a shape in which the section parallel to the Z-axis direction is a right triangle while being arranged on the substrate 30. The third prism 226 is arranged on the substrate 30 such that an inclined surface 226a is positioned on an upper side in the Z-axis direction and a longitudinal direction of a bottom surface (surface facing the inclined surface 226a) 226b is in parallel with the X-axis direction. The third prism 226 is arranged in a direction in which the inclined surface 226a having a right triangle becomes lower toward the supply side of the substrate 30. As shown in FIG. 35, the third prism 226 allows the parallel light F emitted from the light source 221 to be incident from the inclined surface 226a having a right triangle, refracts the parallel light F, and emits the parallel light from the bottom surface 226b having a right triangle.

The fourth prism 227 has a shape in which the section parallel to the Z-axis direction is a right triangle while being arranged on the substrate 30. The fourth prism 227 is arranged on the substrate 30 such that an inclined surface 227a is positioned on an upper side in the Z-axis direction and a longitudinal direction of a bottom surface (surface facing the inclined surface 227a) 227b is in parallel with the X-axis direction. The fourth prism 227 is arranged in a direction in which the inclined surface 227a having a right triangle becomes lower toward the winding side of the substrate 30. As shown in FIG. 35, the fourth prism 227 allows the parallel light F emitted from the light source 221 to be incident from the inclined surface 227a having a right triangle, refracts the parallel light F, and emits the parallel light from the bottom surface 227b having a right triangle.

In the process of exposing the negative photosensitive resin layer 33, if the parallel light F emitted from the light source 221 is incident from the inclined surface 224a of the first prism 224 as shown in FIG. 34(a), the parallel light is refracted, is inclined toward the front side of the paper surface in FIG. 33, is emitted from the bottom surface 224b, and is incident on the substrate 30 at an inclined angle (so as to be inclined) with respect to the normal direction thereof.

As shown in FIG. 34(b), if the parallel light F emitted from the light source 221 is incident from the inclined surface 225a of the second prism 225, the parallel light is refracted, is inclined toward the deep side of the paper surface in FIG. 33, is emitted from the bottom surface 225b, and is incident on the substrate 30 at an inclined angle (so as to be inclined) with respect to the normal direction thereof.

As shown in FIG. 35(a), if the parallel light F emitted from the light source 221 is incident from the inclined surface 226a of the third prism 226, the parallel light is refracted, is inclined toward the winding side of the substrate 30, is emitted from the bottom surface 226b, and is incident on the substrate 30 at an inclined angle (so as to be inclined) with respect to the normal direction thereof.

As shown in FIG. 35(b), if the parallel light F emitted from the light source 221 is incident from the inclined surface 227a of the fourth prism 227, the parallel light is refracted, is inclined toward the supply side of the substrate 30, is emitted from the bottom surface 227b, and is incident on the substrate 30 at an inclined angle (so as to be inclined) with respect to the normal direction thereof.

Accordingly, the parallel light F can be applied from the other surface 30b in a state in which the substrate 30 has the inclined angle with respect to the normal direction.

According to the present embodiment, the parallel light F emitted from the light source 221 is refracted using the first prism 224, the second prism 225, the third prism 226 and the fourth prism 227, and thus, the parallel light F can be incident on the substrate 30 at the inclined angle with respect to the normal direction thereof. According to the present embodiment, it is possible to expose the negative photosensitive resin layer 33 by the parallel light F in four different directions.

According to the present embodiment, the light-diffusing member 35 on which the same light-diffusing section 34 of which the taper-shaped side surfaces are inclined in four different directions is obtained.

### (16) Sixteenth Embodiment

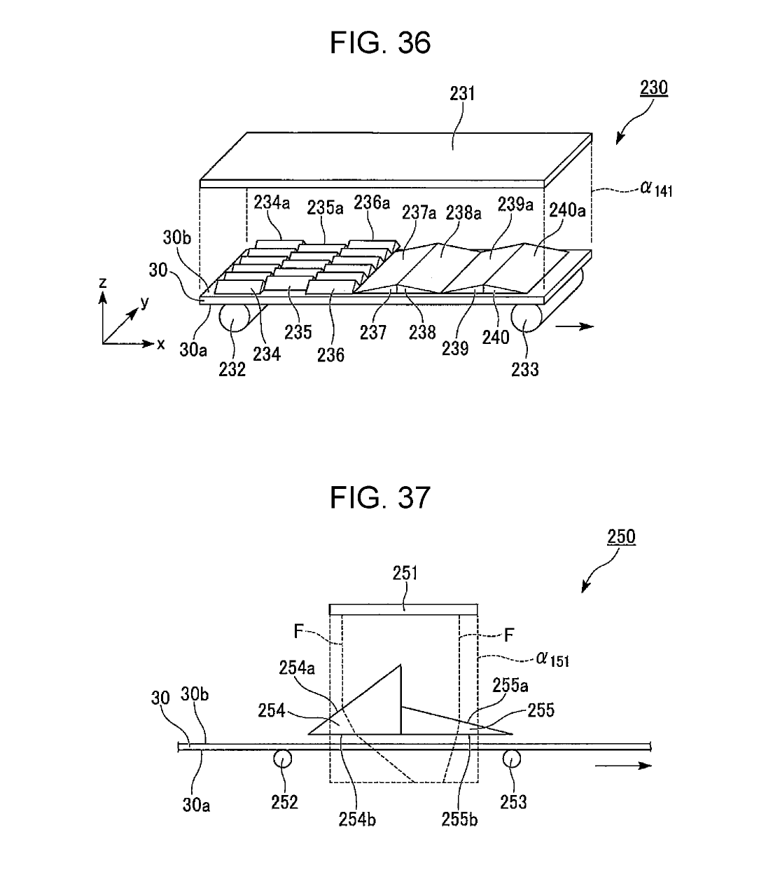

A sixteenth embodiment of the method for manufacturing the light-diffusing member will be described with reference to FIG. 36.

The method for manufacturing the light-diffusing member of the present embodiment is different from the method for manufacturing the light-diffusing member of the above-described first embodiment in that an exposure device 230 shown in FIG. 36 is used as the exposure device in the process of exposing the negative photosensitive resin layer 33. Other processes are the same as those in the method for manufacturing the light-diffusing member of the above-described first embodiment.

In FIG. 36, the same components as those shown in FIG. 2 will be assigned the same reference numerals, and the description thereof will be omitted. In FIG. 36, the light shielding layer 31 and the negative photosensitive resin layer 33 formed on the one surface 30a of the substrate 30 will be omitted.

In FIG. 36, a direction (direction shown by an arrow in FIG. 36) in which the substrate 30 is transferred is referred to as an X-axis direction, a width direction of the substrate 30 is referred to as a Y-axis direction, and a height direction of the exposure device 230 is referred to as a Z-axis direction.

The exposure device 230 schematically includes a light source 231 for irradiating the negative photosensitive resin layer 33 formed on the one surface 30a of the substrate 30 with the parallel light F such as the ultraviolet light, a first roller 232 and a second roller 233 which sequentially support the substrate 30 in the transfer direction, and a first prism 234, a second prism 235, a third prism 236, a fourth prism 237, a fifth prism 238, a sixth prism 239 and a seventh prism 240 which are sequentially arranged so as to be in continuously contact with the substrate 30 in the transfer direction between the substrate 30 transferred by the rollers and the light source.

The light source 231 faces the substrate 30, and is arranged so as to irradiate the substrate 30 with the parallel light F in a direction perpendicular to the transfer direction (X-axis direction).

For example, an ultraviolet lamp is used as the light source 231.

The first roller 232 is arranged on the one surface 30a of the substrate 30 and supports the substrate 30 on the supply side of the substrate 30. The first roller 232 is arranged near one end (end on the supply side of the substrate 30) of a region (exposure region) α₁₄₁ where the negative photosensitive resin layer 33 can be exposed by the light source 231.

The second roller 233 is arranged in the transfer direction of the substrate 30 with a prescribed distance from the first roller 232, and is arranged on the one surface 30a of the substrate 30 and supports the substrate 30 on the winding side of the substrate 30. The second roller 233 is arranged near the other end (end on the winding side of the substrate 30) of the exposure region α₁₄₁ of the substrate 30.

That is, the exposure region α₁₄₁ is formed between the first roller 232 and the second roller 233.

The first prism 234 has a saw blade shape such that unit shapes in which the section parallel to the Z-axis direction is a right triangle while being arranged on the substrate 30 are in continuously contact with one other in parallel. The first prism 234 is arranged on the substrate 30 such that an inclined surface 234a having a saw blade shape is positioned on an upper side in the Z-axis direction and a direction in which the unit shapes having a right triangle are in continuously contact with one another in parallel is in parallel with the Y-axis direction. The first prism 234 is arranged in a direction in which the inclined surface 234a having a right triangle becomes lower toward the deep side of the paper surface. The first prism 234 allows the parallel light F emitted from the light source 231 to be inclined from the inclined surface 234a having a right triangle (surface having a saw blade shape), refracts the parallel light F, and emits the parallel light from the bottom surface of the right triangle.

The second prism 235 has a saw blade shape such that unit shapes in which the section parallel to the Z-axis direction is a right triangle while being arranged on the substrate 30 are in continuously contact with one other in parallel. The second prism 235 is arranged on the substrate 30 such that an inclined surface 235a having a saw blade shape is positioned on an upper side in the Z-axis direction and a direction in which the unit shapes having a right triangle are in continuously contact with one another in parallel is in parallel with the Y-axis direction. The second prism 235 is arranged in a direction in which the inclined surface 235a having a right triangle becomes lower toward the deep side of the paper surface. The second prism 235 allows the parallel light F emitted from the light source 231 to be inclined from the inclined surface 235a having a right triangle (surface having a saw blade shape), refracts the parallel light F, and emits the parallel light from the bottom surface of the right triangle. The second prism 235 is arranged so as to be deviated from the first prism 234 such that the saw blade shape does not overlap with the first prism 234.

The third prism 236 has a saw blade shape such that unit shapes in which the section parallel to the Z-axis direction is a right triangle while being arranged on the substrate 30 are in continuously contact with one other in parallel. The third prism 236 is arranged on the substrate 30 such that an inclined surface 236a having a saw blade shape is positioned on an upper side in the Z-axis direction and a direction in which the unit shapes having a right triangle are in continuously contact with one another in parallel is in parallel with the Y-axis direction. The third prism 236 is arranged in a direction in which the inclined surface 236a having a right triangle becomes lower toward the deep side of the paper surface. The third prism 236 allows the parallel light F emitted from the light source 231 to be inclined from the inclined surface 236a having a right triangle (surface having a saw blade shape), refracts the parallel light F, and emits the parallel light from the bottom surface of the right triangle. The third prism 236 is arranged so as to be deviated from the second prism 235 such that the saw blade shape does not overlap with the second prism 235.

The fourth prism 237 has a shape in which the section parallel to the Z-axis direction is a right triangle while being arranged on the substrate 30. The fourth prism 237 is arranged on the substrate 30 such that an inclined surface 237a is positioned on an upper side in the Z-axis direction and a longitudinal direction of a bottom surface (surface facing the inclined surface 237a) is in parallel with the X-axis direction. The fourth prism 237 is arranged in a direction in which the inclined surface 237a having a right triangle becomes lower toward the supply side of the substrate 30. The fourth prism 237 allows the parallel light F emitted from the light source 231 to be inclined from the inclined surface 237a having a right triangle, refracts the parallel light F, and emits the parallel light from the bottom surface of the right triangle.

The fifth prism 238 has a shape in which the section parallel to the Z-axis direction is a right triangle while being arranged on the substrate 30. The fifth prism 238 is arranged on the substrate 30 such that an inclined surface 238a is positioned on an upper side in the Z-axis direction and a longitudinal direction of a bottom surface (surface facing the inclined surface 238a) is in parallel with the X-axis direction. The fifth prism 238 is arranged in a direction in which the inclined surface 238a having a right triangle becomes lower toward the winding side of the substrate 30. The fifth prism 238 allows the parallel light F emitted from the light source 231 to be inclined from the inclined surface 238a having a right triangle, refracts the parallel light F, and emits the parallel light from the bottom surface of the right triangle.

The sixth prism 239 has a shape in which the section parallel to the Z-axis direction is a right triangle while being arranged on the substrate 30. The sixth prism 239 is arranged on the substrate 30 such that an inclined surface 239a is positioned on an upper side in the Z-axis direction and a longitudinal direction of a bottom surface (surface facing the inclined surface 239a) is in parallel with the X-axis direction. The sixth prism 239 is arranged in a direction in which the inclined surface 239a having a right triangle becomes lower toward the supply side of the substrate 30. The sixth prism 239 allows the parallel light F emitted from the light source 231 to be inclined from the inclined surface 239a having a right triangle, refracts the parallel light F, and emits the parallel light from the bottom surface of the right triangle.

The seventh prism 240 has a shape in which the section parallel to the Z-axis direction is a right triangle while being arranged on the substrate 30. The seventh prism 240 is arranged on the substrate 30 such that an inclined surface 240a is positioned on an upper side in the Z-axis direction and a longitudinal direction of a bottom surface (surface facing the inclined surface 240a) is in parallel with the X-axis direction. The seventh prism 240 is arranged in a direction in which the inclined surface 240a having a right triangle becomes lower toward the winding side of the substrate 30. The seventh prism 240 allows the parallel light F emitted from the light source 231 to be inclined from the inclined surface 240a having a right triangle, refracts the parallel light F, and emits the parallel light from the bottom surface of the right triangle.

In the process of exposing the negative photosensitive resin layer 33, if the parallel light F emitted from the light source 231 is incident from the inclined surface 234a of the first prism 234, the inclined surface 235a of the second prism 235, and the inclined surface 236a of the third prism 236, the parallel light is refracted, is inclined toward the front side of the paper surface in FIG. 36, is emitted from the bottom surface, and is incident on the substrate 30 at the inclined angle (so as to be inclined) with respect to the normal direction.

If the parallel light F emitted from the light source 231 is incident from the inclined surface 237a of the fourth prism 237 and the inclined surface 239a of the sixth prism 239, the parallel light is refracted, is inclined toward the take-out side of the substrate 30, is emitted from the bottom surface, and is incident on the substrate 30 at the inclined angle (so as to be inclined) with respect to the normal direction.

If the parallel light F emitted from the light source 231 is incident from the inclined surface 238a of the fifth prism 238 and the inclined surface 240a of the seventh prism 240, the parallel light is refracted, is inclined toward the supply side of the substrate 30, is emitted from the bottom surface, and is incident on the substrate 30 at the inclined angle (so as to be inclined) with respect to the normal direction.

Accordingly, the parallel light F can be applied from the other surface 30b in a state in which the substrate 30 has the inclined angle with respect to the normal direction.

According to the present embodiment, the parallel light F emitted from the light source 231 is refracted using the first prism 234, the second prism 235, the third prism 236, the fourth prism 237, the fifth prism 238, the sixth prism 239, the seventh prism 240, and thus, the parallel light F can be incident on the substrate 30 at the inclined angle with respect to the normal direction thereof. According to the present embodiment, it is possible to expose the negative photosensitive resin layer 33 by using the parallel light F in three different directions.

According to the present embodiment, the light-diffusing member 35 on which the same light-diffusing section 34 of which the taper-shaped side surfaces are inclined in three different directions is formed is obtained.

Although it has been described in the present embodiment that the first prism 234, the second prism 235 and the third prism 236 which have the saw blade shape are arranged between the first roller 232 and the second roller 233, the present embodiment is not limited thereto. In the present embodiment, two prisms having a saw blade shape may be arranged between the first roller 232 and the second roller 233, or four or more prisms having a saw blade shape may be arranged between the first roller 232 and the second roller 233.

Although it has been described in the present embodiment that the fourth prism 237, the fifth prism 238, the sixth prism 239 and the seventh prism 240 which have a shape in which the section parallel to the Z-axis direction is a right triangle are arranged between the first roller 232 and the second roller 233, the present embodiment is not limited thereto. Two prisms which have a shape in which the section parallel to the Z-axis direction is a right triangle may be arranged between the first roller 232 and the second roller 233, or an even number (six or more) of prisms which have a shape in which the section parallel to the Z-axis direction is a right triangle may be arranged between the first roller 232 and the second roller 233.

### (17) Seventeenth Embodiment

A seventeenth embodiment of the method for manufacturing the light-diffusing member will be described with reference to FIG. 37.

The method for manufacturing the light-diffusing member of the present embodiment is different from the method for manufacturing the light-diffusing member of the above-described first embodiment in that an exposure device 250 shown in FIG. 37 is used as the exposure device in the process of exposing the negative photosensitive resin layer 33. Other processes are the same as those in the method for manufacturing the light-diffusing member of the above-described first embodiment.

In FIG. 37, the same components as those shown in FIG. 2 will be assigned the same reference numerals, and the description thereof will be omitted. In FIG. 37, the light shielding layer 31 and the negative photosensitive resin layer 33 formed on the one surface 30a of the substrate 30 will be omitted.

In FIG. 37, a direction (direction shown by an arrow in FIG. 37) in which the substrate 30 is transferred is referred to as an X-axis direction, a width direction of the substrate 30 is referred to as a Y-axis direction, and a height direction of the exposure device 250 is referred to as a Z-axis direction.

The exposure device 250 schematically includes a light source 251 for irradiating the negative photosensitive resin layer 33 formed on the one surface 30a of the substrate 30 with the parallel light such as the ultraviolet light, a first roller 252 and a second roller 253 which are arranged so as to correspond to a region (exposure region) α₁₅₁ where the negative photosensitive resin layer 33 can be exposed by the light source 251 and sequentially support the substrate 30 in the transfer direction, and a first prism 254 and a second prism 255 which are sequentially arranged so as to be in continuously contact with the substrate 30 in the transfer direction between the substrate 30 transferred by the rollers and the light source.

The light source 251 faces the substrate 30, and is arranged so as to irradiate the substrate 30 with the parallel light F in a direction perpendicular to the transfer direction (X-axis direction).

For example, an ultraviolet lamp is used as the light source 251.

The first roller 252 is arranged on the one surface 30a of the substrate 30 and supports the substrate 30 on the supply side of the substrate 30. The first roller 252 is arranged near one end (end on the supply side of the substrate 30) of the region (exposure region) α₁₅₁ where the negative photosensitive resin layer 33 can be exposed by the light source 251.

The second roller 253 is arranged in the transfer direction of the substrate 30 with a prescribed distance from the first roller 252, and is arranged on the one surface 30a of the substrate 30 and supports the substrate 30 on the winding side of the substrate 30. The second roller 253 is arranged near the other end (end on the winding side of the substrate 30) of the exposure region α₁₅₁ of the substrate 30.

That is, the exposure region α₁₅₁ is formed between the first roller 252 and the second roller 253.

The first prism 254 has a shape in which the section parallel to the Z-axis direction is a right triangle while being arranged on the substrate 30. The first prism 254 is arranged on the substrate 30 such that an inclined surface 254a is positioned on an upper side in the Z-axis direction and a longitudinal direction of a bottom surface (surface facing the inclined surface 254a) 254b is in parallel with the X-axis direction. The first prism 254 is arranged in a direction in which the inclined surface 254a having a right triangle becomes lower toward the supply side of the substrate 30. The first prism 254 allows the parallel light F emitted from the light source 251 to be inclined from the inclined surface 254a having a right triangle, refracts the parallel light F, and emits the parallel light from the bottom surface 254b of the right triangle.

The second prism 255 has a shape in which the section parallel to the Z-axis direction is a right triangle while being arranged on the substrate 30. The second prism 255 is arranged on the substrate 30 such that an inclined surface 255a is positioned on an upper side in the Z-axis direction and a longitudinal direction of a bottom surface (surface facing the inclined surface 255a) 255b is in parallel with the X-axis direction. The second prism 255 is arranged in a direction in which the inclined surface 255a having a right triangle becomes lower toward the winding side of the substrate 30. The second prism 255 allows the parallel light F emitted from the light source 251 to be inclined from the inclined surface 255a having a right triangle, refracts the parallel light F, and emits the parallel light from the bottom surface 255b of the right triangle.

As shown in FIG. 37, the shape of the first prism 254 and the shape of the second prism 255 are different, and the inclined angle with respect to the X-axis direction of the inclined surface 254a of the first prism 254 and the inclined surface with respect to the X-axis direction of the inclined surface 255a of the second prism 255 are different.

The first prism 254 and the second prism 255 are arranged between the first roller 252 and the second roller 253 in the X-axis direction.

In the process of exposing the negative photosensitive resin layer 33, if the parallel light F emitted from the light source 251 is incident from the inclined surface 254a of the first prism 254, the parallel light is refracted, is inclined toward the winding side of the substrate 30, is emitted from the bottom surface 254b of the first prism 254, and is incident on the substrate 30 at the inclined angle (so as to be inclined) with respect to the normal direction.

If the parallel light F emitted from the light source 251 is incident from the inclined surface 255a of the second prism 255, the parallel light is refracted, is inclined toward the supply side of the substrate 30, is emitted from the bottom surface 255b of the second prism 255, and is incident on the substrate 30 at the inclined angle (so as to be inclined) with respect to the normal direction.

Accordingly, the parallel light F can be applied from the other surface 30b in a state in which the substrate 30 has the inclined angle with respect to the normal direction.

According to the present embodiment, the parallel light F emitted from the light source 251 is refracted using the first prism 254 and the second prism 255, and thus, the parallel light F can be incident on the substrate 30 at the inclined angle with respect to the normal direction thereof. According to the present embodiment, it is possible to expose the negative photosensitive resin layer 33 by using the parallel light F in two different directions.

According to the present embodiment, the light-diffusing member 35 on which the same light-diffusing section 34 in which angles (taper angles) of taper-shaped side surfaces 34c1 and 34c2 are bilaterally asymmetrical is formed is obtained on the section of the substrate 30 in the normal direction, as shown in FIG. 22.

Although it has been described in the present embodiment that the first prism 254 and the second prism 255 which have a shape in which the section parallel to the Z-axis direction is a right triangle and have different shapes are arranged between the first roller 252 and the second roller 253, the present embodiment is not limited thereto. In the present embodiment, an even number (four or more) of prisms which have a shape in which the section parallel to the Z-axis direction is a right triangle may be arranged between the first roller 252 and the second roller 253.

Although it has been described in the present embodiment that the first prism 254 is larger than the second prism 255, the present embodiment is not limited thereto. In the present embodiment, the second prism 255 may be larger than the first prism 254.

### (18) Eighteenth Embodiment

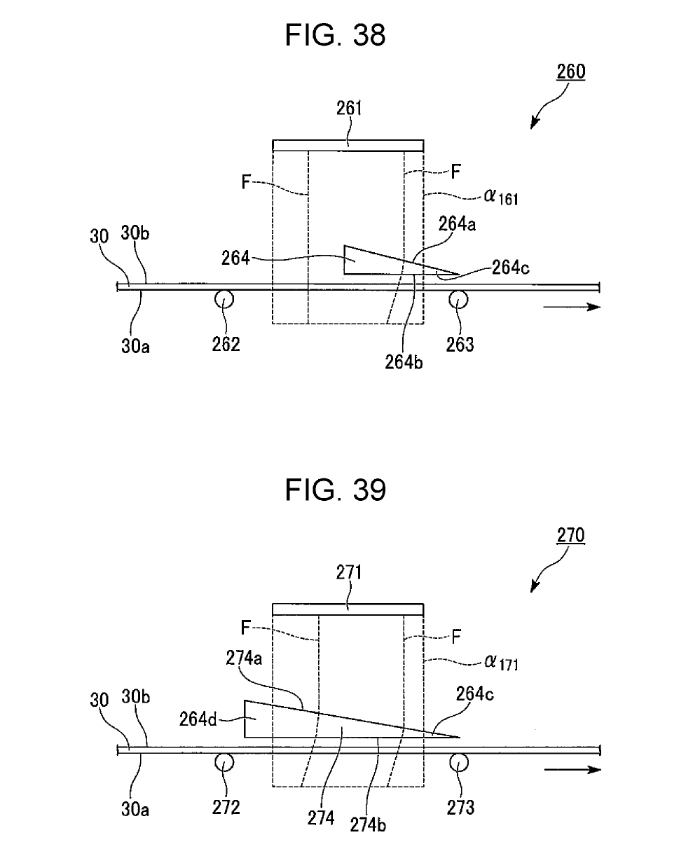

An eighteenth embodiment of the method for manufacturing the light-diffusing member will be described with reference to FIG. 38.

The method for manufacturing the light-diffusing member of the present embodiment is different from the method for manufacturing the light-diffusing member of the above-described first embodiment in that an exposure device 260 shown in FIG. 38 is used as the exposure device in the process of exposing the negative photosensitive resin layer 33. Other processes are the same as those in the method for manufacturing the light-diffusing member of the above-described first embodiment.

In FIG. 38, the same components as those shown in FIG. 2 will be assigned the same reference numerals, and the description thereof will be omitted. In FIG. 38, the light shielding layer 31 and the negative photosensitive resin layer 33 formed on the one surface 30a of the substrate 30 will be omitted.

In FIG. 38, a direction (direction shown by an arrow in FIG. 38) in which the substrate 30 is transferred is referred to as an X-axis direction, a width direction of the substrate 30 is referred to as a Y-axis direction, and a height direction of the exposure device 260 is referred to as a Z-axis direction.

The exposure device 260 schematically includes a light source 261 for irradiating the negative photosensitive resin layer 33 formed on the one surface 30a of the substrate 30 with the parallel light F such as the ultraviolet light, a first roller 262 and a second roller 263 which are arranged so as to correspond to a region (exposure region) α₁₆₁ where the negative photosensitive resin layer 33 can be exposed by the light source 261 and sequentially support the substrate 30 in the transfer direction, and a prism 264 which is arranged between the substrate 30 transferred by the rollers and the light source.

The light source 261 faces the substrate 30, and is arranged so as to irradiate the substrate 30 with the parallel light F in a direction perpendicular to the transfer direction (X-axis direction).

For example, an ultraviolet lamp is used as the light source 261.

The first roller 262 is arranged on the one surface 30a of the substrate 30 and supports the substrate 30 on the supply side of the substrate 30. The first roller 262 is arranged near one end (end on the supply side of the substrate 30) of the region (exposure region) α₁₆₁ where the negative photosensitive resin layer 33 can be exposed by the light source 261.

The second roller 263 is arranged in the transfer direction of the substrate 30 with a prescribed distance from the first roller 262, and is arranged on the one surface 30a of the substrate 30 and supports the substrate 30 on the winding side of the substrate 30. The second roller 263 is arranged near the other end (end on the winding side of the substrate 30) of the exposure region α₁₆₁ of the substrate 30.

That is, the exposure region α₁₆₁ is formed between the first roller 262 and the second roller 263.

The prism 264 has a shape in which the section parallel to the Z-axis direction is a right triangle while being arranged on the substrate 30. The prism 264 is arranged on the substrate 30 such that an inclined surface 264a is positioned on an upper side in the Z-axis direction and a longitudinal direction of a bottom surface (surface facing the inclined surface 264a) 264b is in parallel with the X-axis direction. The prism 264 is arranged in a direction in which the inclined surface 264a having a right triangle becomes lower toward the winding side of the substrate 30. The prism 264 allows the parallel light F emitted from the light source 261 to be inclined from the inclined surface 264a having a right triangle, refracts the parallel light F, and emits the parallel light from the bottom surface 264b of the right triangle.

The prism 264 is arranged between the first roller 262 and the second roller 263 in the X-axis direction.

The prism 264 is arranged such that a part (front end 264c) protrudes from the exposure region α₁₆₁.

In the process of exposing the negative photosensitive resin layer 33, if the parallel light F emitted from the light source 261 is incident in parallel with the normal direction of the substrate 30 in a region (left region of the exposure region α₁₆₁ in FIG. 38) of the exposure region α₁₆₁ where the prism 264 is not arranged and the parallel light F emitted from the light source 261 is incident from the inclined surface 264a of the prism 264 in a region (right region of the exposure region α₁₆₁ in FIG. 38) where the prism 264 is arranged, the parallel light is refracted, is inclined toward the supply side of the substrate 30, is emitted from the bottom surface 264b of the prism 264, and is incident on the substrate 30 at the inclined angle (so as to be inclined) with respect to the normal direction.

According to the present embodiment, the light parallel light F is applied in parallel with the normal direction of the substrate 30 in a region of the exposure region α₁₆₁ where the prism 264 is not arranged, and the parallel light F can be applied at the inclined angle (so as to be inclined) with respect to the normal direction of the substrate 30 in a region where the prism 264 is arranged. Thus, it is possible to expose the negative photosensitive resin layer 33 so as to be bilaterally asymmetrical with respect to the normal direction of the substrate 30.

That is, according to the present embodiment, the light-diffusing member 35 on which the same light-diffusing section 34 in which angles (taper angles) of taper-shaped side surfaces 34c1 and 34c2 are bilaterally asymmetrical is formed is obtained on the section of the substrate 30 in the normal direction, as shown in FIG. 24. Specifically, the side surface 34c1 of the light-diffusing section 34 has an inclined angle with respect to the normal direction of the substrate 30, and the side surface 34c2 of the light-diffusing section 34 is in parallel with the normal direction of the substrate 30.

### (19) Nineteenth Embodiment

A nineteenth embodiment of the method for manufacturing the light-diffusing member will be described with reference to FIG. 39.

The method for manufacturing the light-diffusing member of the present embodiment is different from the method for manufacturing the light-diffusing member of the above-described first embodiment in that an exposure device 270 shown in FIG. 39 is used as the exposure device in the process of exposing the negative photosensitive resin layer 33. Other processes are the same as those in the method for manufacturing the light-diffusing member of the above-described first embodiment.

In FIG. 39, the same components as those shown in FIG. 2 will be assigned the same reference numerals, and the description thereof will be omitted. In FIG. 39, the light shielding layer 31 and the negative photosensitive resin layer 33 formed on the one surface 30a of the substrate 30 will be omitted.

In FIG. 39, a direction (direction shown by an arrow in FIG. 39) in which the substrate 30 is transferred is referred to as an X-axis direction, a width direction of the substrate 30 is referred to as a Y-axis direction, and a height direction of the exposure device 270 is referred to as a Z-axis direction.

The exposure device 270 schematically includes a light source 271 for irradiating the negative photosensitive resin layer 33 formed on the one surface 30a of the substrate 30 with the parallel light F such as the ultraviolet light, a first roller 272 and a second roller 273 which are arranged so as to correspond to a region (exposure region) α₁₇₁ where the negative photosensitive resin layer 33 can be exposed by the light source 271 and sequentially support the substrate 30 in the transfer direction, and a prism 274 which is arranged between the substrate 30 transferred by the rollers and the light source.

The light source 271 faces the substrate 30, and is arranged so as to irradiate the substrate 30 with the parallel light F in a direction perpendicular to the transfer direction (X-axis direction).

For example, an ultraviolet lamp is used as the light source 271.

The first roller 272 is arranged on the one surface 30a of the substrate 30 and supports the substrate 30 on the supply side of the substrate 30. The first roller 272 is arranged near one end (end on the supply side of the substrate 30) of the region (exposure region) α₁₇₁ where the negative photosensitive resin layer 33 can be exposed by the light source 271.

The second roller 273 is arranged in the transfer direction of the substrate 30 with a prescribed distance from the first roller 272, and is arranged on the one surface 30a of the substrate 30 and supports the substrate 30 on the winding side of the substrate 30. The second roller 273 is arranged near the other end (end on the winding side of the substrate 30) of the exposure region α₁₇₁ of the substrate 30.

That is, the exposure region α₁₇₁ is formed between the first roller 272 and the second roller 273.

The prism 274 has a shape in which the section parallel to the Z-axis direction is a right triangle while being arranged on the substrate 30. The prism 274 is arranged on the substrate 30 such that an inclined surface 274a is positioned on an upper side in the Z-axis direction and a longitudinal direction of a bottom surface (surface facing the inclined surface 274a) 274b is in parallel with the X-axis direction. The prism 274 is arranged in a direction in which the inclined surface 274a having a right triangle becomes lower toward the winding side of the substrate 30. The prism 274 allows the parallel light F emitted from the light source 271 to be inclined from the inclined surface 274a having a right triangle, refracts the parallel light F, and emits the parallel light from the bottom surface 274b of the right triangle.

The prism 274 is arranged between the first roller 272 and the second roller 273 in the X-axis direction.

The prism 274 is arranged such that a part (front end 264c and rear end 264d) protrudes from the exposure region α₁₇₁.

In the process of exposing the negative photosensitive resin layer 33, if the parallel light F emitted from the light source 271 is incident from the inclined surface 274a of the prism 274, the parallel light is refracted, is inclined toward the supply side of the substrate 30, is emitted from the bottom surface 274b of the prism 274, and is incident on the substrate 30 at the inclined angle (so as to be inclined) with respect to the normal direction.

Accordingly, the parallel light F can be applied from the other surface 30b in a state in which the substrate 30 has the inclined angle with respect to the normal direction.

According to the present embodiment, the parallel light F can be applied between the first roller 272 and the second roller 273 at the inclined angle (so as to be inclined) with respect to the normal direction of the substrate 30. Accordingly, it is possible to expose the negative photosensitive resin layer 33 by being inclined in one direction with respect to the normal direction of the substrate 30.

According to the present embodiment, the light-diffusing member 35 on which the same light-diffusing section 34 in which angles (taper angles) of taper-shaped side surfaces 34c1 and 34c2 are equal is formed is obtained on the section of the substrate 30 in the normal direction, as shown in FIG. 26. Specifically, the side surface 34c1 of the light-diffusing section 34 and the side surface 34c2 of the light-diffusing section 34 are in parallel with each other.

### (20) Twentieth Embodiment

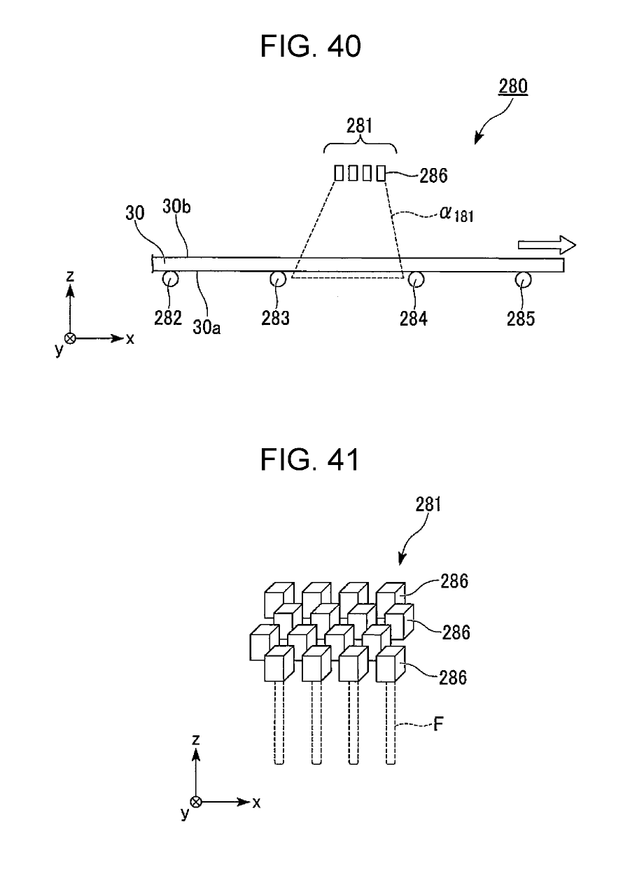

A twentieth embodiment of the method for manufacturing the light-diffusing member will be described with reference to FIGS. 40 to 42.

The method for manufacturing the light-diffusing member of the present embodiment is different from the method for manufacturing the light-diffusing member of the above-described first embodiment in that an exposure device 280 shown in FIG. 40 is used as the exposure device in the process of exposing the negative photosensitive resin layer 33. Other processes are the same as those in the method for manufacturing the light-diffusing member of the above-described first embodiment.

In FIG. 40, the same components as those shown in FIG. 2 will be assigned the same reference numerals, and the description thereof will be omitted. In FIG. 40, the light shielding layer 31 and the negative photosensitive resin layer 33 formed on the one surface 30a of the substrate 30 will be omitted.

In FIG. 40, a direction (direction shown by an arrow in FIG. 40) in which the substrate 30 is transferred is referred to as an X-axis direction, a width direction of the substrate 30 is referred to as a Y-axis direction, and a height direction of the exposure device 280 is referred to as a Z-axis direction.

The exposure device 280 schematically includes a light source 281 for irradiating the negative photosensitive resin layer 33 formed on the one surface 30a of the substrate 30 with the parallel light F such as the ultraviolet light, a first roller 282, a second roller 283, a third roller 284, and a fourth roller 285 which are arranged so as to correspond to a region (exposure region) α₁₈₁ where the negative photosensitive resin layer 33 can be exposed by the light source 281 and sequentially support the substrate 30 in the transfer direction.

The light source 281 faces the substrate 30, and is arranged so as to face the substrate 30.

As shown in FIG. 41, the light source 281 includes a plurality of unit light sources 286 which is arranged adjacent to one another.

For example, the light source 281 is obtained by using a small-sized ultraviolet lamp as the unit light source 286 and arranging a plurality of small-sized ultraviolet lamps so as to be adjacent to one another.

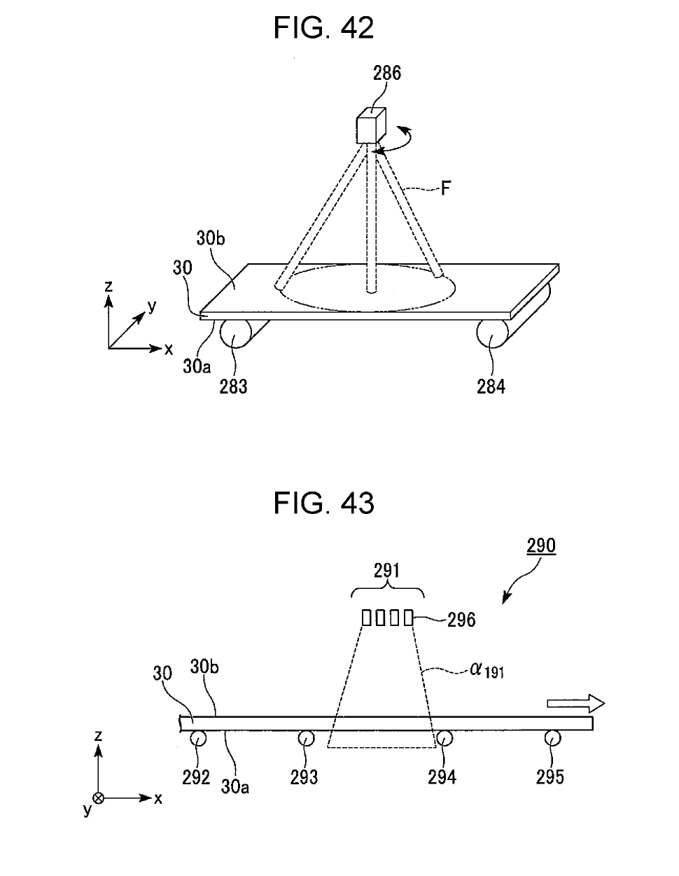

As shown in FIG. 42, each of the unit light sources 286 moves at an arbitrary inclined angle with respect to the X-axis direction and the Y-axis direction, and the substrate 30 is irradiated with the parallel light F at an arbitrary inclined angle.

The first roller 282 is arranged on the one surface 30a of the substrate 30 and supports the substrate 30 on the supply side of the substrate 30.

The second roller 283 is arranged in the transfer direction of the substrate 30 with a prescribed distance from the first roller 282, is arranged on the one surface 30a of the substrate 30, and supports the substrate 30. The second roller 283 is arranged near one end (end on the supply side of the substrate 30) of the region (exposure region) α₁₈₁ where the negative photosensitive resin layer 33 can be exposed by the light source 281.

The third roller 284 is arranged in the transfer direction of the substrate 30 with a prescribed distance from the second roller 283 and the fourth roller 285, is arranged on the one surface 30a of the substrate 30, and supports the substrate 30. The third roller 284 is arranged near the other end (end on the winding side of the substrate 30) of the exposure region α₁₈₁ of the substrate 30.

The fourth roller 285 is arranged in the transfer direction of the substrate 30 with a prescribed distance from the third roller 284, and is arranged on the one surface 30a of the substrate 30 and supports the substrate 30 on the winding side of the substrate 30.

The exposure region α₁₈₁ is formed between the second roller 283 and the third roller 284.

In the process of exposing the negative photosensitive resin layer 33, the plurality of unit light sources 286 constituting the light source 281 moves in the X-axis direction and the Y-axis direction of the substrate 30 at an arbitrary inclined angle, and thus, the parallel light F is applied at an arbitrary inclined angle with respect to the X-axis direction of the substrate 30. Accordingly, the parallel light F can be applied from the other surface 30b in a state in which the substrate 30 has the inclined angle with respect to the normal direction. All the plurality of unit light sources 286 may simultaneously move in the same direction, or may randomly move in different directions.

According to the present embodiment, the parallel light F can be applied between the second roller 283 and the third roller 284 at the inclined angle (so as to be inclined) with respect to the normal direction of the substrate 30. Accordingly, it is possible to expose the negative photosensitive resin layer 33 at the inclined angle in two or more different directions with respect to the normal direction of the substrate 30.

According to the present embodiment, the light-diffusing member 35 on which the same light-diffusing section 34 of which the taper-shaped side surfaces are inclined in two or more different directions is formed is obtained.

### (21) Twenty-First Embodiment

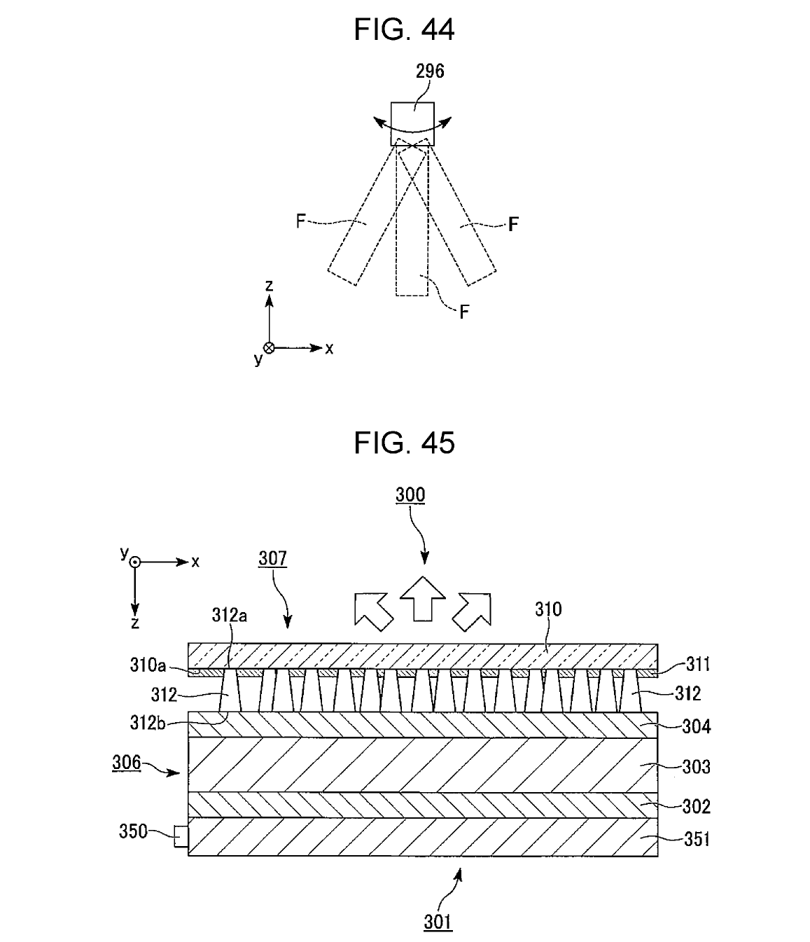

A twenty-first embodiment of the method for manufacturing the light-diffusing member will be described with reference to FIGS. 43 and 44.

The method for manufacturing the light-diffusing member of the present embodiment is different from the method for manufacturing the light-diffusing member of the above-described first embodiment in that an exposure device 290 shown in FIG. 43 is used as the exposure device in the process of exposing the negative photosensitive resin layer 33. Other processes are the same as those in the method for manufacturing the light-diffusing member of the above-described first embodiment.

In FIG. 43, the same components as those shown in FIG. 2 will be assigned the same reference numerals, and the description thereof will be omitted. In FIG. 43, the light shielding layer 31 and the negative photosensitive resin layer 33 formed on the one surface 30a of the substrate 30 will be omitted.

In FIG. 43, a direction (direction shown by an arrow in FIG. 43) in which the substrate 30 is transferred is referred to as an X-axis direction, a width direction of the substrate 30 is referred to as a Y-axis direction, and a height direction of the exposure device 290 is referred to as a Z-axis direction.

The exposure device 290 schematically includes a light source 291 for irradiating the negative photosensitive resin layer 33 formed on the one surface 30a of the substrate 30 with the parallel light F such as the ultraviolet light, and a first roller 292, a second roller 293, a third roller 294, and a fourth roller 295 which are arranged so as to correspond to a region (exposure region) α₁₉₁ where the negative photosensitive resin layer 33 can be exposed by the light source 291 and sequentially support the substrate 30 in the transfer direction.

The light source 291 faces the substrate 30, and is arranged so as to face the substrate 30.

The light source 291 includes a plurality of unit light sources 296 which is arranged in parallel in the transfer direction (X-axis direction) of the substrate 30.

For example, the light source 291 is obtained by using a small-sized ultraviolet lamp as the unit light source 296 and arranging a plurality of small-sized ultraviolet lamps in parallel.

As shown in FIG. 44, each of the unit light sources 296 moves at an arbitrary inclined angle with respect to the X-axis direction, and the substrate 30 is irradiated with the parallel light F at an arbitrary inclined angle with respect to the transfer direction (X-axis direction).

The first roller 282 is arranged on the one surface 30a of the substrate 30 and supports the substrate 30 on the supply side of the substrate 30.

The second roller 293 is arranged in the transfer direction of the substrate 30 with a prescribed distance from the first roller 292, is arranged on the one surface 30a of the substrate 30, and supports the substrate 30. The second roller 293 is arranged near one end (end on the supply side of the substrate 30) of the region (exposure region) α₁₉₁ where the negative photosensitive resin layer 33 can be exposed by the light source 291.

The third roller 294 is arranged in the transfer direction of the substrate 30 with a prescribed distance from the second roller 293 and the fourth roller 295, is arranged on the one surface 30a of the substrate 30, and supports the substrate 30. The third roller 294 is arranged near the other end (end on the winding side of the substrate 30) of the exposure region α₁₉₁ of the substrate 30.

The fourth roller 295 is arranged in the transfer direction of the substrate 30 with a prescribed distance from the third roller 294, and is arranged on the one surface 30a of the substrate 30 and supports the substrate 30 on the winding side of the substrate 30.

The exposure region α₁₉₁ is formed between the second roller 293 and the third roller 294.

In the process of exposing the negative photosensitive resin layer 33, the plurality of unit light sources 296 constituting the light source 291 moves in the X-axis direction of the substrate 30 at an arbitrary inclined angle, and thus, the parallel light F is applied at an arbitrary inclined angle with respect to the X-axis direction of the substrate 30. Accordingly, the parallel light F can be applied from the other surface 30b in a state in which the substrate 30 has the inclined angle with respect to the normal direction. All the plurality of unit light sources 296 may simultaneously move in the same direction, or may randomly move in different directions.

According to the present embodiment, the parallel light F can be applied between the second roller 293 and the third roller 294 at the inclined angle (so as to be inclined) with respect to the normal direction of the substrate 30. Accordingly, it is possible to expose the negative photosensitive resin layer 33 at the inclined angle in two or more different directions with respect to the normal direction of the substrate 30.

According to the present embodiment, the light-diffusing member 35 on which the same light-diffusing section 34 of which the taper-shaped side surfaces are inclined in two or more different directions is formed is obtained.

### Display Device

FIG. 45 is a longitudinal sectional view showing an embodiment of a liquid crystal display device as an example of a display device.

A liquid crystal display device 300 of the present embodiment schematically includes a liquid crystal display member 306 which includes a backlight 301 (light source), a first polarizing plate 302, a liquid crystal panel 303 and a second polarizing plate 304, and a light-diffusing member 307.

One plate-shaped liquid crystal panel 303 is schematically illustrated in FIG. 45, and the structure thereof will be described in detail below. An observer sees the display from the top of the liquid crystal display device 300 in FIG. 45 in which the light-diffusing member 307 is arranged. Thus, in the following description, a side on which the light-diffusing member 307 is referred to as a visual-perception side, and a side on which the backlight 301 is arranged is referred to as a rear side.

In the liquid crystal display device 300, the light emitted from the backlight 301 is modulated in the liquid crystal panel 303, and a prescribed image or character is displayed by the modulated light. If the light emitted from the liquid crystal panel 303 passes through the light-diffusing member 307, an angle distribution of the emitted light becomes wider than that in a case where the light is incident on the light-diffusing member 307, and thus, the light is emitted from the light-diffusing member 307.

Accordingly, the observer can visually perceive the display with a wide viewing angle.

In the liquid crystal display device 300 of the present embodiment, the member manufactured by the method for manufacturing the light-diffusing member of the first to twenty-first embodiments is used as the light-diffusing member 307.

The light-diffusing member 307 schematically includes a substrate 310 having light transparency, a plurality of light shielding layers 311 formed on one surface 310a of the substrate 310, and a light-diffusing section 312 formed in a region other than a region of the one surface 310a of the substrate 310 where the light shielding layers 311 are formed.

The light-diffusing section 312 includes a light emission end surface 312a on the substrate 310, and a light incident end surface 312b having an area greater than an area of the light emission end surface 312a opposite to the substrate 310.

Hereinafter, the specific configuration of the liquid crystal panel 303 will be described.

Although it will be described in this example that an active matrix transmissive liquid crystal panel is used as the liquid crystal panel 303, a liquid crystal panel capable of being applied to the present invention is not limited to the active matrix transmissive liquid crystal panel. For example, the liquid crystal panel capable of being applied to the present invention may be a translucent (transmissive and reflective) liquid crystal panel or a reflective liquid crystal panel, or may be a simple matrix liquid crystal panel in which each pixel does not include a switching thin film transistor (hereinafter, referred to as a “TFT”).

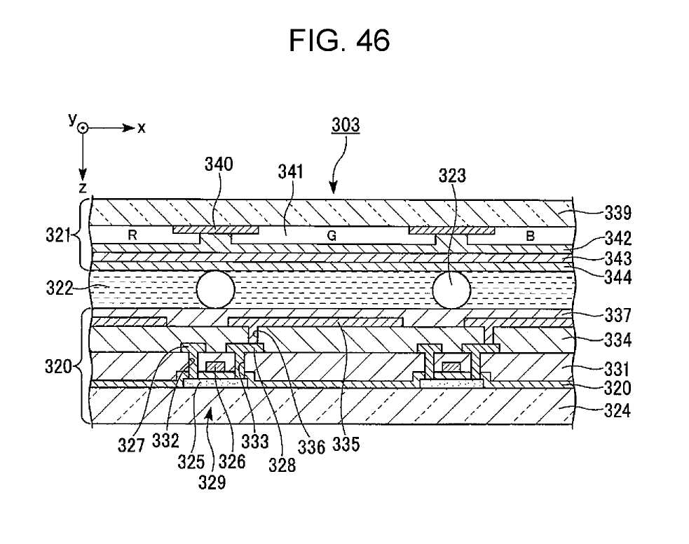

FIG. 46 is a longitudinal section view of the liquid crystal panel 303.

As shown in FIG. 46, the liquid crystal panel 303 includes a TFT substrate 320 as a switching element substrate, a color filter substrate 321 disposed so as to face the TFT substrate 320, and a liquid crystal layer 322 interposed between the TFT substrate 320 and the color filter substrate 321. The liquid crystal layer 322 is sealed within a space surrounded by the TFT substrate 320, the color filter substrate 321, and a frame-shaped sealing member (not shown) which bonds the TFT substrate 320 to the color filter substrate 321 with a prescribed distance. The liquid crystal panel 303 is configured to display in, for example, a vertical alignment (VA) mode, and a vertical alignment liquid crystal having negative dielectric anisotropy is used as the liquid crystal layer 322. Spherical spacers 323 for constantly maintaining the distance between these substrates are arranged between the TFT substrate 320 and the color filter substrate 321. The display mode is not limited to the VA mode, but may include a twisted nematic (TN) mode, a super twisted nematic (STN) mode, and an In-Plane switching (IPS) mode.

On the TFT substrate 320, a plurality of pixels (not shown) which are display minimum units is arranged in a matrix shape. On the TFT substrate 320, a plurality of source bus lines (not shown) is formed so as to extend in parallel with one another, and a plurality of gate bus lines (not shown) is formed so as to extend in parallel with one another and so as to be perpendicular to the plurality of source bus lines. Accordingly, on the TFT substrate 320, the plurality of source bus lines and the plurality of gate bus lines are formed in a grid pattern, and a rectangular region partitioned by the adjacent source bus line and the adjacent gate bus line serves as one pixel. The source bus line is connected to a TFT source electrode to be described below, and the gate bust line is connected to a TFT gate electrode.

On a surface of a transparent substrate 324 of the TFT substrate 320 close to the liquid crystal layer 322, a TFT 329 which includes a semiconductor layer 325, a gate electrode 326, a source electrode 327, and a drain electrode 328 is formed. For example, a glass substrate may be used as the transparent substrate 324. For example, a semiconductor layer 325 made of a semiconductor layer such as continuous grain silicon (CGS), low-temperature poly-silicon (LPS) or amorphous silicon (α-Si) is formed on the transparent substrate 324. A gate insulating film 330 is formed on the transparent substrate 324 so as to cover the semiconductor layer 325. For example, a silicon oxide film, a silicon nitride film, or a laminated film thereof is used as the material of the gate insulating film 330.

A gate electrode 326 is formed on the gate insulating film 330 so as to face the semiconductor layer 325. For example, a laminated film of W (tungsten)/TaN (tantalum nitride), Mo (molybdenum), Ti (titanium) or Al (aluminum) is used as the material of the gate electrode 326.

A first interlayer insulating film 331 is formed on the gate insulating film 330 so as to cover the gate electrode 326.

For example, a silicon oxide film, a silicon nitride film, or a laminated film thereof is used as the material of the first interlayer insulating film 331.

Source electrodes 327 and drain electrodes 328 are formed on the first interlayer insulating film 331. The source electrode 327 is connected to a source region of the semiconductor layer 325 through a contact hole 332 penetrating the first interlayer insulating film 331 and the gate insulating film 330. Similarly, the drain electrode 328 is connected to a drain region of the semiconductor layer 325 through a contact hole 333 penetrating the first interlayer insulating film 331 and the gate insulating film 330.

The same conductive material as that of the above-described gate electrode 326 is used as the material of the source electrode 327 and the drain electrode 328.

A second interlayer insulating film 334 is formed on the first interlayer insulating film 331 so as to cover the source electrodes 327 and the drain electrodes 328.

The same material as that of the above-described first interlayer insulating film 331 or an organic insulating material is used as the material of the second interlayer insulating film 334.

Pixel electrodes 335 are formed on the second interlayer insulating film 334. The pixel electrode 335 is connected to the drain electrode 328 through the contact hole 336 penetrating the second interlayer insulating film 334. Thus, the pixel electrode 335 is connected to the drain region of the semiconductor layer 325 by using the drain electrode 328 as an intermediate electrode.

For example, a transparent conductive material such as indium tin oxide (ITO) or indium zinc oxide (IZO) is used as the material of the pixel electrode 335.

In such a configuration, in a case where a scanning signal is supplied through the gate bus line and the TFT 329 is turned on, a signal supplied to the source electrode 327 via the source bus line is supplied to the pixel electrode 335 via the semiconductor layer 325 and the drain electrode 328. An alignment film 337 is formed on the entire surface of the second interlayer insulating film 334 so as to cover the pixel electrodes 335. The alignment film 337 has an alignment restricting capability of vertically aligning liquid crystal molecules of the liquid crystal layer 322. As the type of TFT, a top-gate type TFT shown in FIG. 2 may be used, or a bottom-gate type TFT may be used.

Meanwhile, a black matrix 340, color filters 341, a planarization layer 342, a facing electrode 343, and an alignment film 344 are sequentially formed on a surface of a transparent substrate 339 of the color filter substrate 321 close to the liquid crystal layer 322.

The black matrix 340 has a function of shielding light transmission in an inter-pixel region, and is formed using a photoresist obtained by dispersing metal such as a multilayer film of Cr (chrome) or Cr/chromium oxide, or carbon particles in photosensitive resin.

Each component of the colors such as red (R), green (G) and blue (B) are included in the color filter 341, any one color filter 341 of R, G and B is arranged on one pixel electrode 335 on the TFT substrate 320 so as to face each other.

The planarization layer 342 is formed as an insulating film that covers the black matrix 340 and the color filters 341, and has a function of achieving planarization by removing stepped portions caused by the black matrix 340 and the color filters 341.

The facing electrode 343 is formed on the planarization layer 342. The same transparent conductive material as that of the pixel electrode 335 is used as the material of the facing electrode 343.

The alignment film 344 having the vertical alignment restricting capability is formed on the entire surface on the facing electrode 343.

The color filters 341 may be implemented as three or more of multiple colors such as R, G and B.

As shown in FIG. 1, the backlight 301 includes a light source 350 such as a light-emitting diode or a cold-cathode tube, and a light guide plate 351 which emits light emitted from the light source 350 toward the liquid crystal panel 303 by using the internal reflection of the light. The backlight 301 may be an edge-lit type in which a light source is arranged on an end surface of a light guide, or may be a direct type in which a light source is arranged immediately below the liquid crystal panel 303. The first polarizing plate 302 serving as a polarizer is provided between the backlight 301 and the liquid crystal panel 303. The second polarizing plate 304 serving as an analyzer is provided between the liquid crystal panel 303 and the light-diffusing member 307.

### INDUSTRIAL APPLICABILITY

The present invention is applicable to various display devices such as a liquid crystal display device, an organic electroluminescence display device, and a plasma display.

### REFERENCE SIGNS LIST

1 Manufacturing apparatus
11 Supply roller
12 Winding roller
13 Printing device
14 Barcode device
15 First drying device
16 Negative photosensitive resin layer forming device
17 Development device
18 Second drying device
19 Exposing device
20 Light source
30 Substrate
31 Light shielding layer
32 Negative photosensitive resin
33 Coating film (negative photosensitive resin layer)
34 Light-diffusing section
35 Light-diffusing member
41 First roller
42 Second roller
43 Third roller
44 Fourth roller
45 Fifth roller
300 Liquid crystal display device
301 Backlight (light source)
302 First polarizing plate
303 Liquid crystal panel
304 Second polarizing plate
306 Liquid crystal display member
307 Light-diffusing member
310 Substrate
311 Light shielding layer
312 Light-diffusing section
320 TFT substrate
321 Color filter substrate
322 Liquid crystal layer
323 Spacer
324 Transparent substrate
325 Semiconductor layer
326 Gate electrode
327 Source electrode
328 Drain electrode
329 TFT
330 Gate insulating film
331 First interlayer insulating film
332, 333 Contact hole
334 Second interlayer insulating film
335 Pixel electrode
337 Alignment film
339 Transparent substrate
340 Black matrix
341 Color filter
342 Polarization layer
343 Facing electrode
344 Alignment film
350 Light source
351 Light guide plate

1. A method for manufacturing a light-diffusing member, the method comprising:
a process of forming a light shielding layer on one surface of a substrate having light transparency;
a process of forming a negative photosensitive resin layer having light transparency on the one surface of the substrate so as to cover the light shielding layer;
a process of exposing the negative photosensitive resin layer by irradiating the negative photosensitive resin layer with parallel light of ultraviolet light diagonally with respect to a normal direction of the one surface of the substrate from a surface opposite to the one surface of the substrate on which the light shielding layer and the negative photosensitive resin layer are formed in at least one direction through a region of the substrate other than a region where the light shielding layer is formed; and
a process of forming a light-diffusing section, which includes a light emission end surface on a side close to the substrate and a light incident end surface having an area greater than an area of the light emission end surface on a side opposite to the substrate, on the one surface of the substrate by developing the exposed negative photosensitive resin layer.

2. The method for manufacturing a light-diffusing member according to claim 1,
wherein the negative photosensitive resin layer is irradiated with the parallel light diagonally with respect to the normal direction of the one surface of the substrate in two or more different directions.

3. The method for manufacturing a light-diffusing member according to claim 2,
wherein angles of the parallel light applied in two or more different directions with respect to the normal direction of the one surface of the substrate are different from each other.

4. The method for manufacturing a light-diffusing member according to claim 1,
wherein the negative photosensitive resin layer is irradiated with the parallel light diagonally with respect to the normal direction of the one surface of the substrate in at least one direction, and the negative photosensitive resin layer is irradiated with the parallel light in parallel with the normal direction of the one surface of the substrate.

5. The method for manufacturing a light-diffusing member according to claim 1,
wherein an angle of the applied parallel light with respect to the normal direction of the one surface of the substrate is controlled by the arrangement of the substrate and a light source which emits the parallel light.

6. The method for manufacturing a light-diffusing member according to claim 5,
wherein the light source includes a plurality of surface light sources, and the plurality of surface light sources is arranged in different directions from one another with respect to the normal direction of the one surface of the substrate.

7. The method for manufacturing a light-diffusing member according to claim 5,
wherein the light source includes a line light source, and the line light source is moved in the normal direction of the one surface of the substrate.

8. The method for manufacturing a light-diffusing member according to claim 1,
wherein a prism is disposed so as to face the substrate, and the angle of the applied parallel light with respect to the normal direction of the one surface of the substrate is controlled by refracting the parallel light emitted from a light source by the prism.

9. A light-diffusing member manufactured by the method for manufacturing a light-diffusing member according to claim 1.

10. A display device comprising the light-diffusing member according to claim 9.
